(19) United States
(12) Patent Application Publication
(10) Pub. No.: US 2025/0209536 A1
(43) Pub. Date: Jun. 26, 2025

(54) METHOD OF PROVIDING RETIREMENT AND ESTATE PLANNING FOR PROPERTY OWNERS OF A RESIDENTIAL NET LEASE

(71) Applicant: Capview Partners, LLC, Dallas, TX (US)

(72) Inventors: John Hammill, Dallas, TX (US); Kevin Connelly, Dallas, TX (US); Danilo da Silva, Dallas, TX (US)

(21) Appl. No.: 19/000,340

(22) Filed: Dec. 23, 2024

Related U.S. Application Data
(60) Provisional application No. 63/614,843, filed on Dec. 26, 2023.

(51) Int. Cl. G06Q 40/06; G06Q 30/0645; G06Q 50/16; G06Q 50/18

(52) U.S. Cl. CPC G06Q 40/06; G06Q 30/0645; G06Q 50/16; G06Q 50/186

(57) ABSTRACT

The present disclosure provides a method for automating a residential net lease management tool that provides risk-return projections associated with net lease terms and financial planning data. Based on market data, a reserve module generates net lease parameters, identifies properties within these parameters, determines costs, generates net lease terms, obtains owner approval, considers financial planning data like retirement allocation or estate planning, uses machine learning models in the financial planning module to create risk-return projections, and displays projections for user interaction.

### CROSS-REFERENCE TO RELATED APPLICATIONS

This application claims priority from U.S. provisional application 63/614,843 filed Dec. 26, 2023, the disclosure of which is incorporated herein by reference.

### FIELD OF THE DISCLOSURE

The present disclosure is generally related to providing retirement and estate planning for property owners of residential net leases.

### BACKGROUND

It is difficult to determine the amount required for a residential net lease tenant to ensure that a lease can be covered in the event of unexpected financial situations. Also, there is a need to determine an amount needed in reserves to ensure that a provider of the residential net lease remains in good standing to increase the provider's credit quality to an investment grade level. Lastly, it is time-consuming and difficult for landlords and property owners to perform sufficient background checks on potential tenants. Once the tenant signs a rental agreement, there are no systems in place to continuously monitor the tenant's financial stability. Additionally, it is difficult for owners of multiple properties to plan for the transfer of their properties upon their death as the process is time-consuming, constantly changing due to personal matters, and tiresome. Also, it is challenging for owners involved in a residential net lease to plan for retirement to ensure a steady cash flow or income flow after the owner has retired from the workforce. Lastly, it is time-consuming to constantly update estate plans since the services or companies that perform estate planning services need up-to-date information on an owner's estate.

There is currently no means for a system that offers residential net leases to property owners to ensure that the tenant will make the rental payments while addressing challenges for owners involved in a residential net lease to plan for retirement or update estate plans in a meaningful manner.

### SUMMARY

Disclosed are systems, apparatuses, methods, computer readable medium, and circuits for automating a residential net lease management tool that provides risk-return projections associated with net lease terms and financial planning data. According to at least one example, a method includes receiving, over an expense network, market data associated with a specific region sent over a communication network at a net lease management server configured to communicate with at least one third-party application. A net lease module may initiate a reserve module. The reserve module may generate net lease parameters for the specific region based on a calculated profitability evaluation based on the market data received via the expense network, wherein the calculated profitability evaluation determines a threshold margin based on a percentage of an average rental rate and average fixed costs in the specific region.

In some cases, the method includes the net lease module initiating an owner module. The owner module may identity properties that fall within the net lease parameters generated by the reserve module. The net lease module may initiate a manage module. The manage module may determine fixed costs and variable costs based on data associated with at least one of the identified properties and extracted data points from stored invoice data. The reserve module may generate a set of net lease terms associated with the at least one of the properties identified by the net lease module, based on inputs including the fixed costs and variable costs determined the manage module, wherein weights are assigned to each input.

In some cases, the method includes the net lease module initiating an enhancement module. The enhancement module may generate one or more stress scenarios based on the net lease terms, extracted historical trend data that impact the fixed costs and variable costs from an expenses database, and an accounting at a single reserve database, wherein the one or more stress scenarios selects a multiplier and a predicted amount for future expenses based on the historical data in varied scenarios. The enhancement module may determine that a backstop database to the single reserve database does not have a sufficient backstop amount to cover the multiplier of the predicted amount based on results of the stress scenario. Based upon the determination and over the communication network, an instruction to trigger a transfer of a difference between the sufficient backstop amount and an accounting at the backstop database to the backstop database may be sent.

In another example, a system for automating a residential net lease management tool with a credit enhancement module is provided that includes a storage (e.g., a memory configured to store data, such as virtual content data, one or more images, etc.) and one or more processors (e.g., implemented in circuitry) coupled to the memory and configured to execute instructions and, in conjunction with various components (e.g., a network interface, a display, an output device, etc.), cause the system to receive, over an expense network, market data associated with a specific region sent over a communication network at a net lease management server configured to communicate with at least one third-party application. A net lease module may initiate a reserve module. The reserve module may generate net lease parameters for the specific region based on a calculated profitability evaluation based on the market data received via the expense network, wherein the calculated profitability evaluation determines a threshold margin based on a percentage of an average rental rate and average fixed costs in the specific region.

In some cases, the instructions cause the system to initiate an owner module. The owner module may identity properties that fall within the net lease parameters generated by the reserve module. The net lease module may initiate a manage module. The manage module may determine fixed costs and variable costs based on data associated with at least one of the identified properties and extracted data points from stored invoice data. The reserve module may generate a set of net lease terms associated with the at least one of the properties identified by the net lease module, based on inputs including the fixed costs and variable costs determined the manage module, wherein weights are assigned to each input.

In some cases, an approval from a property owner of the generated set of net lease terms is received. A financial planning module may determine that the property owner is associated with financial planning data including at least one of retirement allocation data or estate planning data. In some cases, a first machine-learning model of a financial planning module may generate risk-return projections based on second inputs including the net lease terms and the financial planning data, wherein second weights are assigned to each second input. The risk-return projections associated with the net lease terms and the financial planning data may be caused to be displayed.

### BRIEF DESCRIPTION OF THE SEVERAL VIEWS OF THE DRAWINGS

Aspects of the present disclosure will be described more fully hereinafter with reference to the accompanying drawings in which like numerals represent like elements throughout the several figures, and in which example aspects of this disclosure are shown. Aspects of the claims may, however, be embodied in many different forms and should not be construed as limited to the aspects as set forth herein. The examples set forth herein are non-limiting examples and are merely examples among other possible examples.

FIG. 1 illustrates a system for providing a method of providing a residential net lease network with a credit enhancement module.

FIG. 2 illustrates an example method performed by a net lease module.

FIG. 3 illustrates an example method performed by a reserve module.

FIG. 4 illustrates an example method performed by an owner module.

FIG. 5 illustrates an example method performed by an investor module.

FIG. 6 illustrates an example method performed by a manage module.

FIG. 7 displays an example method performed by the retirement module.

FIG. 8 displays an example method performed by the connection module.

FIG. 9 illustrates a block diagram of an exemplary computing system that may be used to implement an embodiment of the present invention.

FIG. 10 illustrates an example neural network architecture.

### DETAILED DESCRIPTION

Embodiments of the present disclosure will be described more fully hereinafter with reference to the accompanying drawings in which like numerals represent like elements throughout the several figures and in which example embodiments are shown. Embodiments of the claims may, however, be embodied in many different forms and should not be construed as limited to the embodiments set forth herein. The examples set forth herein are non-limiting examples and are merely examples among other possible examples.

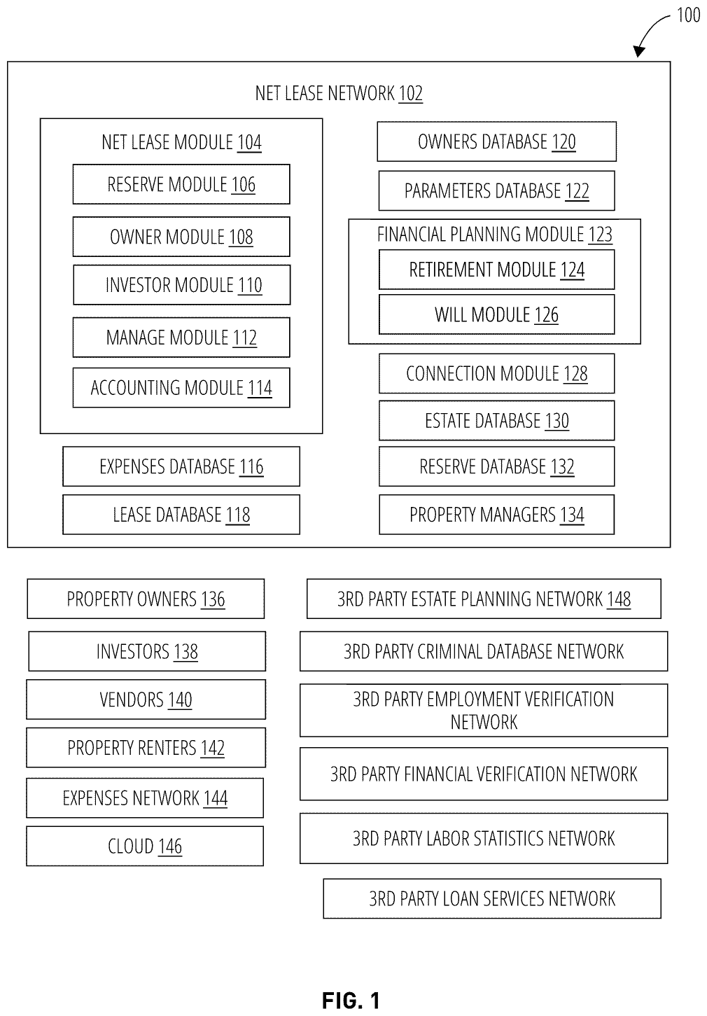

FIG. 1 illustrates a net lease system 100 that provides retirement and estate planning for property owners of residential net leases. The net lease system 100 may comprise a net lease network 102, which may be a software system or process to calculate a long-term, net lease payment to property owners 136 of residential rental properties for a 15 to 25-year primary term and provide landlords with more net operating income for the first five to nine years in exchange for an up-front initial lease reserve fee that allows the lessee to absorb all property level expenses and meet the agreed terms of the lease and make all net lease payments. The absolute net lease means that the lessee pays the landlord (lessor) a fixed lease payment according to a lease payment schedule in exchange for full control and uninterrupted rights to the property as if it were owned by the lessee for the period of the primary lease term and any renewal options it executes. These rights include the right to rent the property to sub-tenants/renters to generate rental income. The lessee is responsible for all property-level expenses including, but not limited to, taxes, insurance, maintenance, utilities, capital expenditures, replacement and repair of FF&E and real property, management, etc.

The net lease system 100 may further include a net lease module 104, which begins by connecting to the expenses network 144. The net lease module 104 receives the data from the expenses network 144. The net lease module 104 store the data from the expenses network 144 in the expenses database 116. The net lease module 104 initiates the reserve module 106. The net lease module 104 initiates the owner module 108. The net lease module 104 initiates the investor module 110. The net lease module 104 extracts the first owner from the owners database 120. The net lease module 104 connects to the vendors 140. The net lease module 104 determines the fixed and variable costs for the property. The net lease module 104 creates the net lease terms for the property owner. The net lease module 104 determines if the property owner 136 approved the net lease terms. If it is determined that the property owner 136 approved the net lease terms, the net lease module 104 assigns a property manager 134 to the property. The net lease module 104 stores the data in the lease database.

The net lease module 104 determines if the property owner 136 currently has an estate planner. If it is determined that the property owner 136 does not have an estate planner, the net lease module 104 initiates the retirement module 124. If it is determined that the property owner 136 does have an estate planner, the net lease module 104 initiates the connection module 128. If it is determined that the property owner 136 did not approve of the net lease terms or after the data is stored in the lease database 118, the net lease module 104 determines if any property owners are 136 remaining in the owners database 120. If it is determined that more owners are remaining in the owners database 120, the net lease module 104 extracts the next owner from the owners database 120, and the process returns to connecting to the vendors 140. If it is determined that there are no more owners remaining in the owners database 120, the net lease module 104 initiates the manage module 112. Then the net lease module 104 initiates the accounting module 114, and the process returns to connecting to the expenses network 144.

The net lease system 100 may further include a reserve module 106, which begins by being initiated by the net lease module 104. The reserve module 106 extracts the first region from the expenses database 116. The reserve module 106 creates the region's net lease parameters. The reserve module 106 stores the parameters in the parameters database 122. The reserve module 106 determines if there are any more regions remaining in the expenses database 116. If it is determined that more regions remain in the expenses database 116, the reserve module 106 extracts the next region from the expenses database 116, and the process returns to creating the parameters for the net lease for the region. If it is determined that there are no more regions remaining in the expenses database 116, the reserve module 106 returns to the net lease module 104.

The net lease system 100 may further include an owner module 108, which begins by being initiated by the net lease module 104. The owner module 108 connects to the property owners 136. The owner module 108 identifies the potential property owners that may have a property that is within the parameters for a net lease. The owner module 108 sends a notification to the property owners 136 that have a property that fulfills the parameters for a net lease. The owner module 108 determines if the owner approved the notification. If the owner approves of the notification, the owner module 108 receives the property details from the property owner 136. The owner module 108 stores the data in the owners database 120. If it is determined that the owner did not approve of the notification or after the data is stored in the owners database 120, the owner module 108 returns to the net lease module 104.

The net lease system 100 may further include an investor module 110, which begins by being initiated by the net lease module 104. The investor module 110 connects to the investors 138. The investor module 110 identifies potential investors for investment in the reserve database 132. The investor module 110 sends a notification to the investors 138. The investor module 110 receives the investment from the investors 138. The investor module 110 stores the received investment from the investors 138 in the reserve fund 24. The investor module 110 returns to the net lease module 104.

The net lease system 100 may further include a manage module 112, which begins by being initiated by the net lease module 104. The manage module 112 extracts the first data entry in the lease database 118. The manage module 112 determines the fixed and variable costs for the property. The manage module 112 pays the costs of the property. The manage module 112 collects rent from the property renters 142. The manage module 112 stores the rent in the reserve database 132. The manage module 112 determines if there are more data entries remaining in the lease database 118. If it is determined that there are more data entries remaining in the lease database 118, the manage module 112 extracts the next data entry from the lease database 118. If it is determined that there are no more data entries remaining in the lease database 118, the manage module 112 returns to the net lease module 104.

The net lease system 100 may further include an accounting module 114, initiated by the net lease module 104. The accounting module 114 determines the payment to the property owners 136. The accounting module 114 sends the payment to the property owners 136. The accounting module 114 determines the profits of the residential investments. The accounting module 114 sends the profits of the residential investments to the investors 138. The accounting module 114 returns to the net lease module 104.

The net lease system 100 may further include an expenses database 116, which contains the location of where the market data is for, the starting market rent, the market growth rate, the inflation rate, the vacancy rate, the rent collectability rate, the home price appreciation, the operating expenses which are stored as a data file and may contain the local taxes, the insurance rates, the management fees, the maintenance budget, the homeowners association fees, the cost of utilities, and the asset management fees. In some embodiments, the market data may be for a specific location or region or may be specific to a certain property location. In some embodiments, each of the data points stored in the database may be used as an input into an algorithm to determine the net lease terms for the property owner 136, determine the rent for the specific property, and determine the profits or return on investment for the investors 138. In some embodiments, the starting market price may be the cost per square footage, the average cost of rent in a certain location, the average cost of rent in a certain location based on the number of bedrooms, the average cost of rent in a certain region of a city or town, etc. In some embodiments, the net lease module 104 may send a request to the expenses network 144 to receive relevant data points for a specific property location, for example, by using the mailing address.

The net lease system 100 may further include an lease database 118 which contains a property owner ID, the property ID, the length of the lease or the years remaining on the net lease, the lease payment to the property owner 136, the annual increase of the net lease payment to the property owner, the fixed and variable costs per month for the property, the rent collected per month for the property, and the monthly profits for the property. In some embodiments, a property owner 136 may have multiple properties under a net lease with the net lease network 102. In some embodiments, the fixed and variable costs may differ for each property, or if there are multiple properties located within a certain radius, there may be one vendor 140 and/or one property manager 134 for each of the properties to lower the monthly fixed and variable costs. In some embodiments, the database may be shown as monthly, quarterly, or annual payments, expenses, profits, etc. In some embodiments, the investors 138 may receive a percentage of the monthly profits or may be paid out based on quarterly or annual profits.

The net lease system 100 may further include an owners database 120, which contains the list of owners interested in receiving net lease terms from the net lease network 102. The database contains the owner's name, the owner ID, the property ID, the property address, the square footage, the number of bedrooms, and the number of bathrooms. In some embodiments, the owner may send the net lease network 102 more data on the location, such as average utility bills, property tax, insurance costs, condition of the property, condition of current appliances, etc. In some embodiments, the owner may send the net lease network 102 the current rates they charge for rent, if the property is vacant or if it currently has renters, the application processes the owner uses for renters, etc.

The net lease system 100 may further include a parameters database 122, which contains the parameters created during the process described in the reserve module 106 that are used to determine if a potential property would be profitable for a residential net lease from the net lease network 102. The database contains the location or region, the square foot range of the property, the number of bedrooms, the number of bathrooms, the rent range that could be charged for the property, the average range of fixed and variable costs for the property, and the potential profit range of the property. In some embodiments, the database may contain a plurality of locations based on the region of the country, the state the property resides in, the city where the property is located, the town or section of a city the property is located, etc. In some embodiments, the parameters may be determined by the property's square footage, the number of bedrooms the property has, the rent that may be charged for the residential property, or a combination of the parameters.

The net lease system 100 may further include a retirement module 124, which begins by being initiated by the net lease module 104. The retirement module 124 sends a request to the property owner 136 for retirement allocations and retirement data. The retirement module 124 receives the retirement allocations and retirement data from the property owners 136. The retirement module 124 stores the property owners 136 retirement allocations and retirement data in the estate database 130. The retirement module 124 initiates the will module 126.

In some cases, the retirement module 124 may incorporate machine-learning through predictive modeling. For example, the retirement module 124 may include a predictive model that takes into account historical data on property appreciation, rental yields, and expenses to estimate potential returns on investment for long-term net leases. The retirement module 124 may further provide risk analysis by utilizing AI-powered risk analysis tools to identify potential risks associated with retirement planning, such as inflation, market fluctuations, or changes in tax laws. This can help property owners make informed decisions about their retirement plans. The retirement module 124 may further create a recommendation engine that suggests optimal investment strategies based on the property owner's individual goals and circumstances. For example, if the property owner is nearing retirement age, the recommendation engine may recommend strategies to preserve income or minimize taxes. The retirement module 124 may further use automated planning tools that use natural language processing (NLP) to analyze the property owner's estate planning documents and identify potential areas for improvement.

The net lease system 100 may further include a will module 126, which begins by being initiated by the retirement module 124. The will module 126 sends a request to the property owner 136 for the beneficiaries of their properties. The will module 126 receives the beneficiaries for the properties of the property owner 136. The will module 126 stores the beneficiaries for the properties of the property owner 136 in the estate database 130. The will module 126 determines if the property owner 136 has other inputs. If it is determined that the property owner 136 has any other inputs, the will module 126 receives the additional inputs from the property owners 136. The will module 126 stores the additional inputs from the property owner 136 in the estate database 130. If it is determined that the property owner 136 does not have any additional inputs or after the additional inputs have been stored in the estate database 130, the will module 126 returns to the net lease module 104.

In some cases, the will module 126 may apply machine-learning intent analysis and use machine learning algorithms to analyze the property owner's intentions regarding their estate plan, including their wishes for distribution of assets after death. The will module 126 may include an AI-powered tool that predicts the likelihood of probate based on factors such as the complexity of the estate, the number of beneficiaries, and the type of assets involved. The will module 126 may further utilize machine-learning models to optimize tax planning strategies by analyzing data on income, expenses, and asset values. This can help minimize taxes owed upon death or transfer of assets. The will module 126 may further include an AI-powered matching system that recommends optimal beneficiary assignments based on individual relationships, financial goals, and other factors.

The net lease system 100 may further include a connection module 128, initiated by the net lease module 104. The connection module 128 sends a request to the property owner 136 for the estate planning company data. The connection module 128 receives the estate planning company data from the property owner 136. The connection module 128 connects to the 3rd party estate planning network 144. The connection module 128 sends a request to the 3rd party estate planning network 144 for the property owner's 136 data. The connection module 128 receives the property owner's 136 estate planning data from the 3rd party estate planning network 144. The connection module 128 stores the property owner's 136 estate planning data in the estate database 130. The connection module 128 determines if there are any updates to the property owner's 136 property. If it is determined that there are updates to the property owner's 136 property, the connection module 128 extracts the property data from the owners database 120. The connection module 128 sends the extracted property data from the owners database 120 to the 3rd party estate planning network 144. If it is determined that there are no updates to the property owner's 136 property or after the data is sent to the 3rd party estate planning network 144, the connection module 128 returns to the net lease module 104.

The net lease system 100 may further include an estate database 130, which contains the estate planning and retirement data of the property owners 136, which is collected either through the processes described in the retirement module 124 and will module 126 or the connection module 128. The database contains the name of the property owner 136, the property owner ID 136, the total amount of the lease payments made to the property owner 136 through their residential net lease terms, the retirement allocations from the total amount of the lease payments, the retirement account the retirement allocations are made to, the first property ID of the property owner 136, the beneficiary of the first property, the additional property ID of the property owner 136, the beneficiary of the additional property, the first bank account of the property owner 136, the beneficiary of the first bank account, the additional bank account of the property owner 136, the beneficiary of the additional bank account, the first investment of the property owner 136, the beneficiary of the first investment, the additional investment of the property owner 136, the beneficiary of the additional investment, and a data file containing the will of the property owner 136.

In some embodiments, the database may contain additional information about the property, such as the address, the renter information, the rental agreement, the yearly increase in the payments for the residential net lease, etc. In some embodiments, the retirement account may be a separate bank account of the property owner 136, an investment portfolio, an IRA fund, a 401K, etc. In some embodiments, the beneficiaries may include the beneficiaries' name, date of birth, address, phone number, e-mail address, etc. In some embodiments, the bank accounts of the property owner 136 may be a checking account, savings account, etc. In some embodiments, the investments of the property owner 136 may be a registered retirement savings plan (RRSP), a tax-free savings account (TFSA), an investment portfolio, an IRA fund, a 401K, etc. In some embodiments, the will data file may include the property owner's 136 last will and testament that may be signed and notarized in which a copy is stored in the database on the net lease network 102.

The net lease system 100 may further include a reserve database 132 in which the investors 138 investment is stored as capital in the event that the net lease networks 102 expenses are greater than the returns, or profits from the residential rental properties, to ensure payment to the property owners 136 according to the terms of their net lease. The reserve database 132 may also be used to expand a line of credit for the net lease network 102 to add more residential rental properties to the lease database by attracting more property owners 136. The reserve database 132 may extend debt as an investment to get a return on funds. In some embodiments, the reserve database 132 may be stored and managed by a third party, such as a bank or financial institution. In some embodiments, the reserve database 132 may be used for unexpected costs such as unexpected vacancy of the residential rental property, capital expenditures, variable costs, etc.

The net lease system 100 may further include a plurality of property managers 134, which may be a person or firm charged with operating a real estate property for a fee. For example, the property manager 134 may be required to find/evict tenants, deal with tenants, and coordinate with the net lease network 102. In addition, such arrangements may require the property manager 134 to collect rent and pay necessary expenses and taxes, making periodic reports to the owner, or the net lease network 102 may delegate specific tasks and deal with others directly. A property manager 134 may arrange for a wide variety of services, as may be requested by the net lease network 102, for a fee. Where a dwelling (vacation home, second home) is only periodically occupied, the property manager 134 might arrange for heightened security monitoring, house-sitting, storage and shipping of goods, and other local sub-contracting necessary to make the property comfortable for when a new tenant rents the property.

The net lease system 100 may further include a plurality of property owners 136, which may be residential property owners that engage in a long-term net lease with the net lease network 102 to eliminate variability that comes with renting residential properties and decrease the time spent on making the residential rental property profitable. The long-term net lease with the net lease network 102 allows the property owner 136 to remove themselves from the responsibility of managing the property, paying taxes on the property, paying insurance on the property, maintaining the property, paying for utilities, paying for capital expenditures of the property, etc. and moving the responsibility to the net lease network 102 in exchange for net lease payment allowing the net lease network 102 controlling rights of the property.

The net lease system 100 may further include a plurality of investors 138, which provide an investment to the net lease network 102 to find residential properties to engage in long-term net leases in exchange for a percentage of the profits made by the net lease network 102 on the residential properties as the return on the investment.

The net lease system 100 may further include a plurality of vendors 140 which may be the source of where the property managers 134 are assigned to the various residential rental properties and take care of the management of the property, management of the leases for the tenants, manage the maintenance of the property, track and collect rent from the tenants, track and maintain the relationship with the tenants, and manage the vacancy of the residential property.

The net lease system 100 may further include a plurality of property renters 142, which sign a rental agreement with the net lease network 102 to rent the residential property. The property renters 142 may pay a monthly rental fee to live in the property, and the agreement may cover certain costs, such as heat, water, electricity, internet, etc. In some embodiments, the net lease network 102 may use a plurality of vendors 140 to assign property managers 134 to the residential rental property to take care and maintain the property on behalf of the net lease network 102 while collecting rent fees, paying fixed and variable costs, and maintain the relationship with the property renters 142.

The net lease system 100 may further include an expenses network 144, which includes a plurality of market data for the properties engaged or about to be engaged in a long-term net lease with the net lease network 102. The expenses network 144 may contain data for specific locations, cities, regions, or states to allow the most up-to-date market data for the net lease network 102 to use to create the net lease terms. The expenses network 144 may contain, for each specific location, the starting market rent, the market growth rate, the inflation rate, the vacancy rate, the rent collectability rate, the home price appreciation, and the operating expenses, which are stored as a data file and may contain the local taxes, the insurance rates, the management fees, the maintenance budget, the homeowner's association fees, the cost of utilities, and the asset management fees. In some embodiments, the expenses network 144 may be connected to a plurality of third-party networks to compile the market data. In some embodiments, the expenses network 144 may continuously update the market data or may collect the specific market data based on a request from the net lease network 102. In some embodiments, the expenses network 144 may store the market data in a plurality of databases to extract and send the data as it is requested from the net lease network 102.

The net lease system 100 may further include a cloud 146, which is a distributed network of computers comprising servers and databases. A cloud 146 may be a private cloud 146, where access is restricted by isolating the network, preventing external access, or using encryption to limit access to only authorized users. Alternatively, a cloud 146 may be a public cloud 146 where access is widely available via the internet. A public cloud 146 may not be secured or may include limited security features.

The net lease system 100 may further include a 3rd party real estate planning network 144, which may be an estate planning company, law firm, etc., that the property owner 136 uses for estate planning which may include retirement data, estate planning data, beneficiary data, etc. For example, estate planning is the process of anticipating and arranging, during a person's life, for the management and disposal of that person's estate during the person's life, in the event the person becomes incapacitated and after death. In some embodiments, the property owner's 136 estate planning may be performed or completed by a lawyer, accountant, financial planner, life insurance advisor, banker, and a broker.

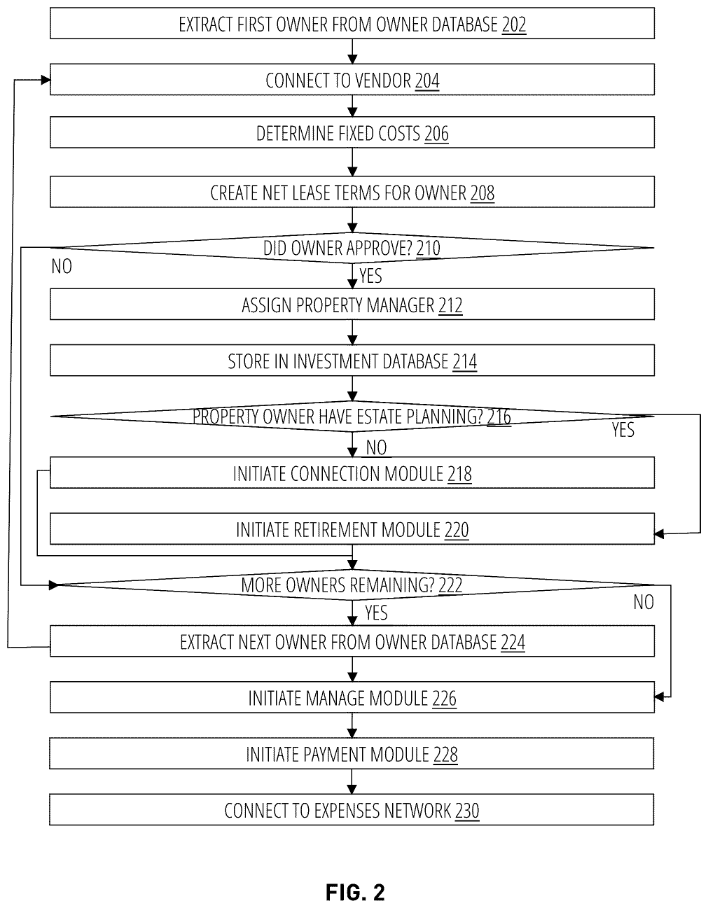

FIG. 2 displays an example method performed by the net lease module 104. Although the example method depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

The example method may begin with the net lease module 104 connecting to the expenses network 144. For example, the net lease module 104 connects to the expenses network 144 through the cloud 146. In some embodiments, the connection may include a request from the net lease module 104 to receive the market data stored in the expenses network 144. In some embodiments, if the expenses network 144 connects to a plurality of third-party networks for the market data, the net lease module 104 may connect to each third-party network to request the market data individually. In some embodiments, the request from the net lease module 104 may include a specific location, city, region, state, etc., for the desired market data.

The net lease module 104 may receive the data from the expenses network 144. For example, the net lease module 104 receives the market data from the expenses network 144, such as the starting market rent, the market growth rate, the inflation rate, the vacancy rate, the rent collectability rate, the home price appreciation, the operating expenses which are stored as a data file and may contain the local taxes, the insurance rates, the management fees, the maintenance budget, the homeowner's association fees, the cost of utilities, and the asset management fees.

The net lease module 104 may store the data from the expenses network 144 in the expenses database 116. For example, the net lease module 104 stores the market data in the expenses database 116, such as the starting market rent, the market growth rate, the inflation rate, the vacancy rate, the rent collectability rate, the home price appreciation, the operating expenses which are stored as a data file and may contain the local taxes, the insurance rates, the management fees, the maintenance budget, the homeowner's association fees, the cost of utilities, and the asset management fees.

The net lease module 104 may initiate the reserve module 106. For example, the reserve module 106 begins by being initiated by the net lease module 104. The reserve module 106 extracts the first region from the expenses database 116. The reserve module 106 creates the region's net lease parameters. The reserve module 106 stores the parameters in the parameters database 122. The reserve module 106 determines if there are any more regions remaining in the expenses database 116. If it is determined that more regions remain in the expenses database 116, the reserve module 106 extracts the next region from the expenses database 116, and the process returns to creating the parameters for the net lease for the region. If it is determined that there are no more regions remaining in the expenses database 116, the reserve module 106 returns to the net lease module 104.

The net lease module 104 may initiate the owner module 108. For example, the owner module 108 begins by being initiated by the net lease module 104. The owner module 108 connects to the property owners 136. The owner module 108 identifies the potential property owners that may have a property that is within the parameters for a net lease. The owner module 108 sends a notification to the property owners 136 that have a property that fulfills the parameters for a net lease. The owner module 108 determines if the owner approved the notification. If the owner approves the notification, the owner module 108 receives the property details from the property owner 136. The owner module 108 stores the data in the owners database 120. if it is determined that the owner did not approve of the notification or after the data is stored in the owners database 120, the owner module 108 returns to the net lease module 104.

The net lease module 104 may initiate the investor module 110. For example, the investor module 110 begins by being initiated by the net lease module 104. The investor module 110 connects to the investors 138. The investor module 110 identifies potential investors for investment in the reserve database 132. The investor module 110 sends a notification to the investors 138. The investor module 110 receives the investment from the investors 138. The investor module 110 stores the received investment from the investors 138 in the reserve fund 24. The investor module 110 returns to the net lease module 104.

The net lease module 104 may extract, at step 202, the first owner from the owners database 120. For example, the net lease module 104 extracts the data entry for the first owner and the first property for the owner, such as the property's location, the square footage, the number of bedrooms, and the number of bathrooms. In some embodiments, the data may include the average cost of utilities, property tax, insurance costs, condition of the property, condition of current appliances, the current rates they charge for rent, if the property is vacant or if it currently has renters, the application process the owner uses for renters, etc.

The net lease module 104 connects, at step 204, to the vendors 140. For example, the net lease module 104 connects to the vendors 140 through the cloud 146 to find the average fixed and variable costs for the vendors in the region, city, state, etc., the property is located in. In some embodiments, the net lease module 104 may have a plurality of agreements with a plurality of vendors 140 in a plurality of locations to assign property managers to maintain the residential properties.

The net lease module 104 determines, at step 206, the fixed and variable costs for the property. For example, the net lease module 104 may determine the fixed and variable costs for each of the properties, such as by invoices inputted by vendors 140 or the property managers 134, extracting the operating expenses from the expenses database 116, etc.

The net lease module 104 creates, at step 208, the net lease terms for the property owner. For example, the net lease module 104 may determine the residential property's location and then use the data stored in the expenses database 116 as inputs into an algorithm that outputs the net lease payment terms for the property owner 136. For example, if the residential rental property is located in Boston, MA, then the starting market rent, the market growth rate, the inflation rate, the vacancy rate, the rent collectability rate, the home price appreciation, the operating expenses such as the local taxes, the insurance rates, the management fees, the maintenance budget, the homeowners association fees, the cost of utilities, and the asset management fees would be used as inputs into the algorithm to determine the net lease payment.

For example, the algorithm may use the average rent per square footage and the square footage of the property owners 136 residential properties to determine the cost of rent for the property, such the average rent per square foot is $4.50 in Boston, MA, and the property owners 136 property is 800 square feet, resulting in a rent price of $3,600 per month. The other inputs, such as the market growth rate, the inflation rate, the vacancy rate, the rent collectability rate, the home price appreciation, the operating expenses, etc., may be used in the algorithm as weighted averages or percentages to increase or decrease the rental rate of the property. The algorithm may offer the property owner 136 net lease terms based on a percentage of the possible rent that the net lease network 102 could charge tenants, such as 75% or $2,700 per month, over the length of 15 years, allowing the property owner 136 to be free of the responsibilities associated with renting a property and providing them with a steady payment for the residential rental property.

In some embodiments, the property owner 136 may be offered an annual increase percentage of the net lease payment due to inflation, market growth rate, etc. The net lease module 104 determines, at decision block 210, if the property owner 136 approves the net lease terms. For example, the property owner 136 may send the signed agreements back to the net lease module 104 or net lease network 102 to approve the net lease terms. In some embodiments, the property owner 136 may have a login, such as a username and a password, account, access to the net lease network 102, etc., to approve the net lease terms. In some embodiments, an administrator of the net lease network 102 may collect the signed agreements from the property owners 136 and store the data in the net lease network 102 to approve the net lease terms.

If it is determined that the property owner 136 approved of the net lease terms, the net lease module 104 assigns, at step 212, a property manager 134 to the property. For example, the net lease module 104 may assign a property manager 134 to the residential property. In some embodiments, the property manager 134 may be assigned by one of the vendors 140 with the net lease network 102 has an agreement with. In some embodiments, the property manager 134 may be a person or firm charged with operating a real estate property for a fee. For example, the property manager 134 may be required to find/evict tenants, deal with tenants, and coordinate with the net lease network 102. In addition, such arrangements may require the property manager 134 to collect rents and pay necessary expenses and taxes, making periodic reports to the owner, or the net lease network 102 may delegate specific tasks and deal with others directly.

The net lease module 104 stores, at step 214, the data in the lease database. For example, the net lease module 104 stores the data created from the net lease terms in the lease database 118, such as a property owner ID, the property ID, the length of the lease or the years remaining on the net lease, the lease payment to the property owner 136, the annual increase of the net lease payment to the property owner, the fixed and variable costs per month for the property, the rent collected per month for the property, etc.

The net lease module 104 determines, at decision block 216, if the property owner 136 currently has an estate planner. For example, the net lease module 104 may send a notification to the property owner 136 if they have estate planning completed or if they require estate planning to be performed. If it is determined that the property owner 136 does not have an estate planner, the net lease module 104 initiates, at step 220, the retirement module 124. For example, the retirement module 124 begins by being initiated by the net lease module 104. The retirement module 124 sends a request to the property owner 136 for retirement allocations and retirement data. The retirement module 124 receives the retirement allocations and retirement data from the property owners 136. The retirement module 124 stores the property owners 136 retirement allocations and retirement data in the estate database 130. The retirement module 124 initiates the will module 126.

If it is determined that the property owner 136 does have an estate planner, the net lease module 104 initiates, at step 218, the connection module 128. For example, the connection module 128 begins by being initiated by the net lease module 104. The connection module 128 requests the property owner 136 for the estate planning company data. The connection module 128 receives the estate planning company data from the property owner 136. The connection module 128 connects to the 3rd party estate planning network 144. The connection module 128 requests the 3rd party estate planning network 144 for the property owner's 136 data. The connection module 128 receives the property owner's 136 estate planning data from the 3rd party estate planning network 144. The connection module 128 stores the property owner's 136 estate planning data in the estate database 130. The connection module 128 determines if there are any updates to the property owner's 136 property. If it is determined that there are updates to the property owner's 136 property, the connection module 128 extracts the property data from the owners database 120. The connection module 128 sends the extracted property data from the owners database 120 to the 3rd party estate planning network 144. If it is determined that there are no updates to the property owner's 136 property or after the data is sent to the 3rd party estate planning network 144, the connection module 128 returns to the net lease module 104.

If it is determined that the property owner 136 did not approve of the net lease terms or after the data is stored in the lease database 118, the net lease module 104 determines, at decision block 222, if there are any property owners 136 remaining in the owners database 120. If it is determined that more owners are remaining in the owners database 120, the net lease module 104 extracts, at step 224, the next owner from the owners database 120, and the process returns to connecting to the vendors 140.

If it is determined that no more owners are remaining in the owners database 120, the net lease module 104 initiates, at step 226, the manage module 112. For example, the manage module 112 begins by being initiated by the net lease module 104. The manage module 112 extracts the first data entry in the lease database 118. The manage module 112 determines the fixed and variable costs for the property. Variable costs may include estimates of future capital expenditures needed on the property. The manage module 112 pays the costs of the property. The manage module 112 collects rent from the renters 142. The manage module 112 stores the rent in the reserve database 132. The manage module 112 determines if there are more data entries remaining in the lease database 118. If it is determined that there are more data entries remaining in the lease database 118, the manage module 112 extracts the next data entry from the lease database 118. If it is determined that there are no more data entries remaining in the lease database 118, the manage module 112 returns to the net lease module 104.

Then the net lease module 104 initiates, at step 228, the accounting module 114, and the process returns to connecting to the expenses network 144. For example, the accounting module 114 begins by being initiated by the net lease module 104. The accounting module 114 determines the payment to the property owners 136. The accounting module 114 sends the payment to the property owners 136. The accounting module 114 determines the profits of the residential investments. The accounting module 114 sends the profits of the residential investments to the investors 138. The accounting module 114 returns to the net lease module 104 in step 230.

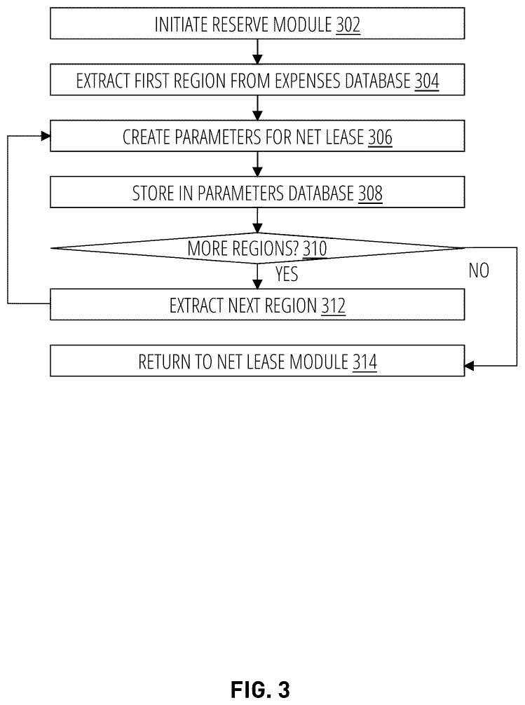

FIG. 3 displays an example method performed by the reserve module. Although the example method depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

The example method may begin with the reserve module 106 being initiated, at step 302, by the net lease module 104. In some embodiments, the reserve module 106 may not need to be initiated and is continuously running in the background of the net lease network 102. The reserve module 106 extracts, at step 304, the first region from the expenses database 116. For example, the reserve module 106 extracts the first region from the expenses database 116, such as the state, city, town, etc., that the expenses data and market data are related to. The reserve module 106 creates, at step 306, the parameters for the net lease for the region. For example, the reserve module 106 may use the data stored in the expenses database to create parameters for residential net leases to identify residential properties that would be profitable with a residential net lease.

For example, if the reserve module 106 may calculate an average range that could be charged for rent depending on the cost per square foot, such as if renters in Boston, MA, typically pay $4.50 per square foot of a property and the average square footage of a studio apartment is 800 square feet to 1,000 square feet, the average rent for a studio apartment may be $3,600 to $4,500. In some embodiments, the calculations may incorporate the number of bedrooms and bathrooms to adjust the average rental price based on square footage. In some embodiments, the calculations may incorporate the area's average fixed and variable costs of properties. In some embodiments, the calculations may use the average rental price and average fixed and variable costs to determine the average profit of a rental property. In some embodiments, the calculations may use a percentage of the average rental price to determine the average payment to a property owner 136 to determine the profits, for example, if the average rent price was $3,600 a month and the owner 136 typically received a payment of 80% for a net lease agreement then the calculations would subtract the 80% for the net lease and the fixed and variable costs to determine the average monthly profit of a residential rental property.

The reserve module 106 stores, at step 308, the parameters in the parameters database 122. For example, the reserve module 106 may store all the data from the calculating the parameters in the parameters database 122, such as the location or region, the square foot range of the property, the number of bedrooms, the number of bathrooms, the rent range that could be charged for the property, the average range of fixed and variable costs for the property, and the potential profit range of the property. The reserve module 106 determines, at decision block 310, if there are any more regions remaining in the expenses database 116. For example, if there are more regions, cities, towns, etc., in the expenses database 116, the reserve module 106 extracts the next region, and the process returns to determine the region's parameters. If it is determined that more regions remain in the expenses database 116, the reserve module 106 extracts, at step 312, the next region from the expenses database 116, and the process returns to creating the parameters for the net lease for the region. If it is determined that there are no more regions remaining in the expenses database 116, the reserve module 106 returns, at step 314, to the net lease module 104.

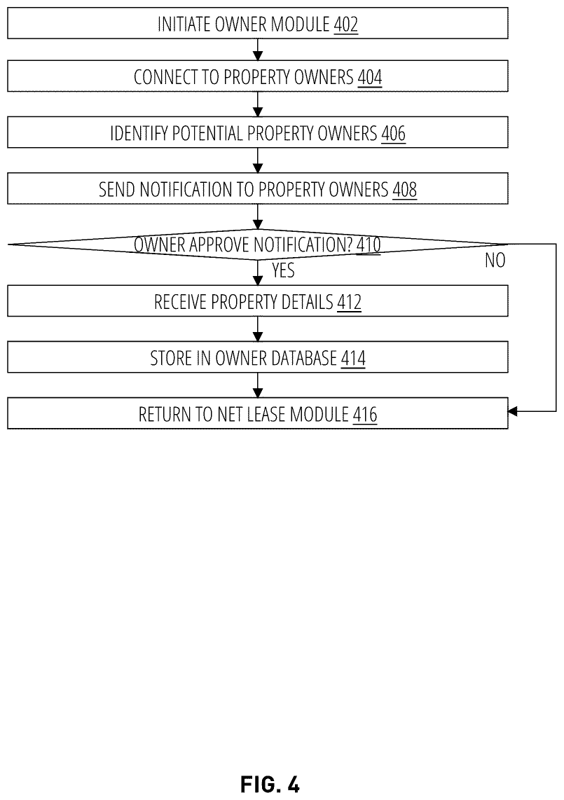

FIG. 4 displays an example method performed by the owner module. Although the example method depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

The process begins with the owner module 108 being initiated, at step 402, by the net lease module 104. In some embodiments, the owner module 108 may not need to be initiated and is continuously running in the background of the net lease network 102. The owner module 108 connects, at step 404, to the property owners 136. For example, the owner module 108 connects to the property owners 136 through the cloud 146, owners 136 may log in to the net lease network 102, sign up to the net lease network 102, etc. In some embodiments, the owner module 108 may find potential property owners 136 through rental listings, apartment listings, etc., and offer the property owner 136 the net lease terms once they are created. In some embodiments, the property owner 136 may be required to input their information, such as name, location of the residential rental property, e-mail address, etc., to receive the net lease terms from the owner module 108.

The owner module 108 identifies, at step 406, the potential property owners that may have a property that is within the parameters for a net lease. For example, the owner module 108 may identify residential properties that would be candidates for residential net leases by comparing the readily available data on the properties to the parameters stored in the parameter database 122. For example, the owner 136 may send data to the owner module 108, such as square footage, number of bedrooms, number of bathrooms, current rent, etc., and the owner module 108 compares the received data to the parameters database 122 to determine if the received data falls within the parameters. In some embodiments, the owner module 108 may use third-party sources to extract the data on the residential properties to determine if the property falls within the range of the parameters stored in the parameter database 122.

The owner module 108 sends, at step 408, a notification to the property owners 136 that have a property that fulfills the parameters for a net lease. For example, if the residential property data is within the parameters of the parameter database 122, then the owner module 108 may send a notification, such as an e-mail, automated phone call, notification through the net lease network 102, etc., to the owner. In some embodiments, the owner module 108 may send the owner an estimate of a potential net lease agreement.

The owner module 108 determines, at step 410, if the owner approved the notification. For example, the owner module 108 determines if the owner 136 responds to the notification either by e-mail, logging onto the net lease network 102, etc. If the owner approves the notification, the owner module 108 receives, at step 412, the property details from the property owner 136. For example, the owner 136 sends the owner module the data related to the residential property, such as the square footage, number of bedrooms, number of bathrooms, current condition of the property, the current condition of the appliances, current rent, the current property management group, etc.

The owner module 108 stores, at step 414, the data in the owners database 120. For example, the owner module 108 stores the received data in the owners database 120, such as the owner's name, the owner ID, the property ID, the property address, the square footage, the number of bedrooms, and the number of bathrooms, average utility bills, property tax, insurance costs, condition of the property, condition of current appliances, current rates they charge for rent, if the property is vacant or if it currently has renters, the application process the owner uses for renters, etc. if it is determined that the owner did not approve of the notification or after the data is stored in the owners database 120 the owner module 108 returns, at step 416, to the net lease module 104.

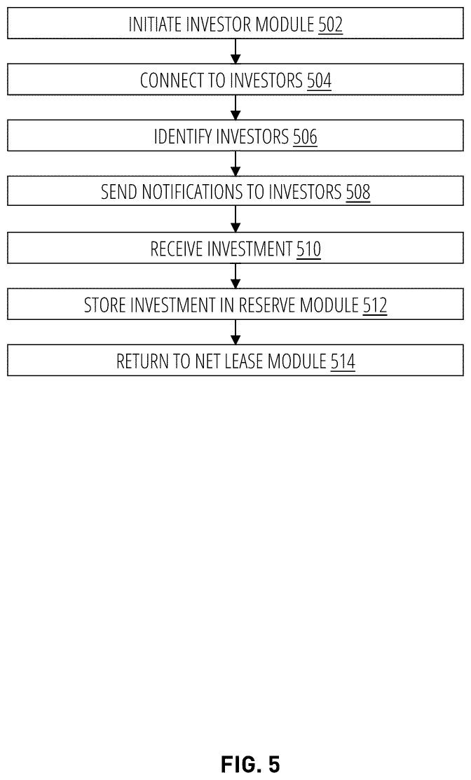

FIG. 5 displays an example method performed by the investor module. Although the example method depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

The process begins with the investor module 110 being initiated, at step 502, by the net lease module 104. In some embodiments, the investor module 110 may not need to be initiated and is continuously running in the background of the net lease network 102. The investor module 110 connects, at step 504, to the investors 138. For example, the investor module 110 may connect to the investors 138 through the cloud 146, investors may log in to the net lease network 102, sign up to the net lease network 102, etc. In some embodiments, the investor module 110 may provide the investors 138 with certain documents such as income statements, balance sheets, capital requirements, investor agreements, term sheets, business plans, etc. The investor module 110 identifies, at step 506, potential investors for an investment into the reserve database 132. For example, the investor module 110 may identify potential investors for investment by collecting e-mails of investors that visit the net lease network 102, sign up for the net lease network 102 by creating a username and password, etc.

The investor module 110 sends, at step 508, a notification to the investors 138. For example, the investor module 110 may send an e-mail notification, notification through the net lease network 102, etc., to notify the investors. In some embodiments, the investor module 110 may provide the investors 138 with certain documents such as income statements, balance sheets, capital requirements, investor agreements, term sheets, business plans, etc.

The investor module 110 receives, at step 510, the investment from the investors 138. For example, the investor module 110 receives an investment from the investor 138, which may include a certain amount of capital to invest in the net lease agreements for residential rental properties. In some embodiments, the investor module 110 may send the investor 138 the investment agreement, contract, etc. The investor module 110 stores, at step 512, the received investment from the investors 138 in the reserve fund 24. For example, the investor module 110 stores the received investment in the reserve database 132 in which the investors 138 investment is stored as capital in the event that the net lease networks 102 expenses are greater than the returns, or profits from the residential rental properties, to ensure payment to the property owners 136 according to the terms of their net lease.

The reserve database 132 may also be used to expand a line of credit for the net lease network 102 to add more residential rental properties to the lease database by attracting more property owners 136. The reserve fund?? may be funded entirely through the upfront fees paid by property owners 136. The calculation of the upfront fee paid by the property owner 136 may be based on an underwriting algorithm that identifies the relative risk of each property owner 136 and the market. In some embodiments, the reserve database 132 may be stored and managed by a third party, such as a bank or financial institution. In some embodiments, the reserve database 132 may be used for unexpected costs such as unexpected vacancy of the residential rental property, capital expenditures, variable costs, etc. The investor module 110 returns, at step 514, to the net lease module 104.

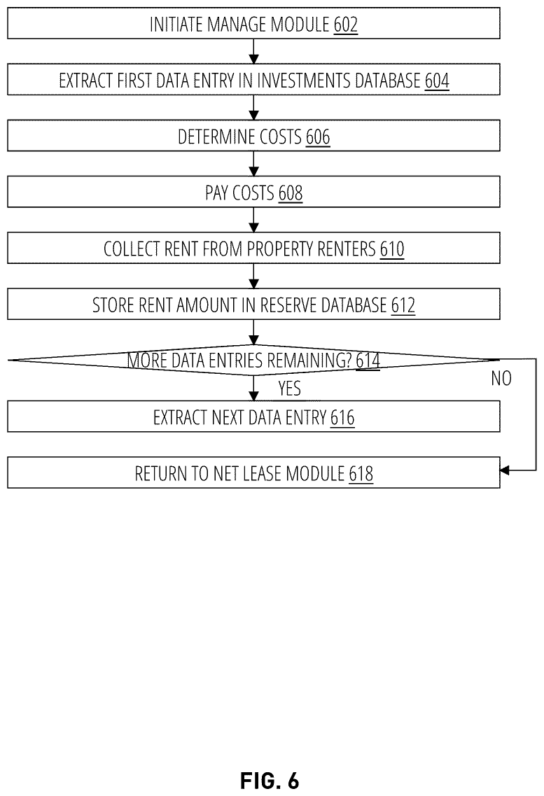

FIG. 6 displays an example method performed by the manage module. Although the example method depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

The process begins with the manage module 112 being initiated, at step 602, by the net lease module 104. In some embodiments, the manage module 112 may not need to be initiated and is continuously running in the background of the net lease network 102. The manage module 112 extracts, at step 604, the first data entry in the lease database 118. For example, the manage module extracts the first data entry in the lease database 118, such as the first property, including the manage module 112 determines, at step 606, the fixed and variable costs for the property. For example, the manage module 112 may determine the fixed and variable costs for each property, such as by invoices inputted by vendors 140 or the property managers 134, extracting the operating expenses from the expenses database 116, etc. In some embodiments, the property manager 134 may be responsible for the sending invoices of the fixed and variable costs for each property, and the manage module 112 may extract the funds from the reserve database 132 to pay for the invoices.

The manage module 112 pays, at step 608, the costs of the property. For example, the manage module 112 may pay for the costs of the property through sending the payment from the reserve database 132 to the vendors 140 or property manager 134. In some embodiments, the vendors 140 or property manager 134 may submit invoices to be paid through the net lease network 102, and the manage module 112 extracts the payment from the reserve database 132 and sends the payment to the vendors 140 or property manager 134. The manage module 112 collects, at step 610, rent from the property renters 142. For example, the manage module 112 may collect the rent from the residential rental properties by sending a notification to the property manager 134 or receiving a notification from the property manager 134 to determine if the rent for the rental property has been collected for the month. In some embodiments, the property manager 134 may use the manage module 112 or net lease network 102 to collect rent from the tenants, such as by the tenants' signing into the net lease network 102 and sending the payment electronically.

The manage module 112 stores, at step 612, the rent in the reserve database 132. For example, the manage module 112 stores that the rent has been collected and stores the amount collected for each rental property in the reserve database 132. In some embodiments, the rent may be stored in the reserve database 132 to be used to pay for the fixed and variable costs of the rental property. In some embodiments, the reserve database 132 may be used to pay for fixed or variable costs for other rental properties being managed by the net lease network 102. In some embodiments, the rent payment may be stored in the reserve database 132 by connecting the renter to the net lease network 102 and submitting the payment, which is automatically transferred to the financial account of the reserve database 132.

The manage module 112 determines, at decision block 614, if there are more data entries remaining in the lease database 118. For example, the manage module 112 extracts the next data entry to pay the next property's costs and collect the next property's rent until all of the properties in the lease database 118 have paid the associated property costs and collected rent from all of the property renters 142. If it is determined that there are more data entries remaining in the lease database 118, the manage module 112 extracts, at step 616, the next data entry from the lease database 118. If it is determined that no more data entries remain in the lease database 118, the manage module 112 returns, at step 618, to the net lease module 104.

In some cases, the accounting module 114 may be initiated by the net lease module 104. In some embodiments, the accounting module 114 may not need to be initiated and is continuously running in the background of the net lease network 102. The accounting module 114 determines the payment to the property owners 136. For example, the accounting module 114 may determine the payment to the property owner 136 by extracting the net lease payment from the lease database 118 and extracting the amount from the reserve database 132 to send to the property owner 136.

In some embodiments, if a property owner 136 has multiple properties on the net lease network 102, the accounting module 114 may filter the lease database 118 on the property owner 136 ID and determine the sum of all the net lease payments owed to the property owner 136 and extract the funds from the reserve database 132 to send to the property owner 136. In some embodiments, if there is a plurality of property owners 136, the accounting module 114 may extract a first property owner 136 and determine the payment, send the payment, and then select the next property owner 136 until all the property owners 136 are stored in the lease database 118 are paid. In some embodiments, the payments may be determined by the net lease terms and sent based on a specific schedule, and may be paid out monthly, quarterly, annually, etc.

The accounting module 114 sends the payment to the property owners 136. For example, the accounting module 114 may send the net lease payment to the property owner 136 by extracting the amount owed to the property owner 136 from the reserve database 132 and sending the payment electronically to the property owner 136. The accounting module 114 determines the profits of the residential investments. For example, the accounting module 114 may determine the profits of the residential investments by extracting the payment to the property owners 136, the cost of the properties, and the rent collected on the property. Then the accounting module 114 may add the payment to the property owners and the cost of the property together and subtract the total from the rent collected to determine the monthly profit of the property. The accounting module 114 may add the sum of all the profits for the residential rental properties to determine the total profit. In some embodiments, the profits may be stored in the lease database 118. In some embodiments, the profits may be determined monthly, quarterly, annually, etc. An example lease database is provided below.

| | | | | Lease | | | |
|---|---|---|---|---|---|---|---|
| Property | Property | Lease | Lease | Payment | Fixed | Rent | Monthly |
| Owner ID | ID | Length | Payment | Increase | Costs | Collected | Profits |
| JS123 | JS123-001 | 15 years | $2,000/month | 1% | $100/month | $2,500/month | $400 |
| JS123 | JS123-002 | 14 years | $2,200/month | 1% | $110/month | $2,700/month | $390 |
| JS123 | JS123-003 | 14 years | $1,800/month | 1.50% | $90/month | $2,300/month | $410 |
| — | — | — | — | — | — | — | — |
| TM456 | TM456-001 | 12 years | $3,000/month | 2% | $150/month | $3,700/month | $550 |
| TM456 | TM456-002 | 12 years | $2,500/month | 1.50% | $125/month | $3,200/month | $575 |
| TM456 | TM456-003 | 10 years | $2,800/month | 1.50% | $135/month | $3,400/month | $465 |
| — | — | — | — | — | — | — | — |
| HY789 | HY789-001 | 15 years | $2,300/month | 1% | $115/month | $2,900/month | $485 |
| HY789 | HY789-002 | 10 years | $2,200/month | 1% | $110/month | $2,800/month | $490 |
| HY789 | HY789-003 | 10 years | $2,500/month | 1.50% | $125/month | $3,100/month | $475 |
| — | — | — | — | — | — | — | — |
| — | — | — | — | — | — | — | — |
| — | — | — | — | — | — | — | — |

The accounting module 114 sends the profits of the residential investments to the investors 138. For example, the accounting module 114 may send the profits to investors 138 that had invested in the net lease network 102. For example, the investors 138 may have a certain percentage of profits they are entitled to based upon their investor agreement. For example, if an investor 138 agreed to invest $1,000 for 1% of the profits and the total monthly profits were $4,000, then the investor 138 would be entitled to $40 for the monthly profits. In some embodiments, the investor agreements may be stored in the net lease network 102. In some embodiments, the accounting module 114 may extract each investor 138 agreement and the percentages of the profits that they are owed and extract the amount from the reserve database 132 to pay the investors 138 their return on investment. In some embodiments, the investors 138 may be paid out monthly, quarterly, annually, etc. The accounting module 114 returns to the net lease module 104.

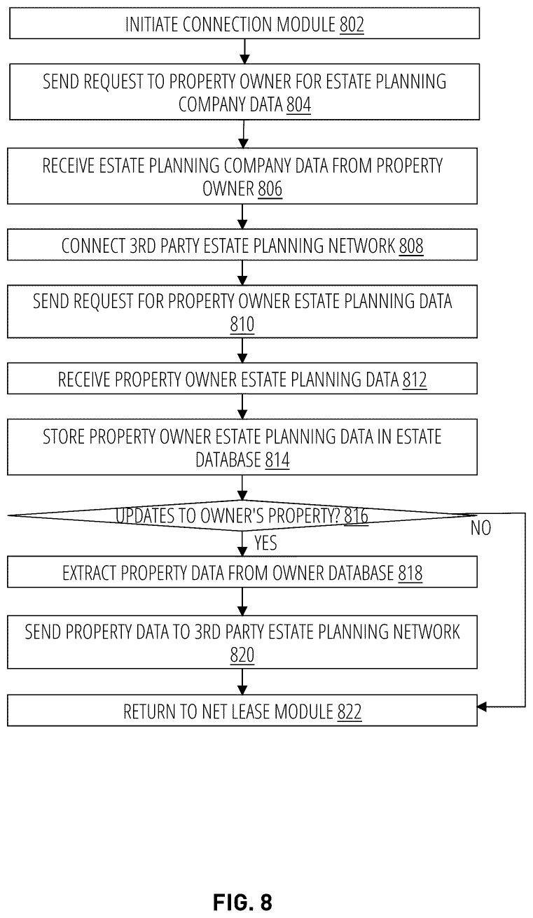

FIG. 8 displays the expenses database 116. The database may contain the location of where the market data is for, the starting market rent, the market growth rate, the inflation rate, the vacancy rate, the rent collectability rate, the home price appreciation, and the operating expenses, which is stored as a data file and may contain the local taxes, the insurance rates, the management fees, the maintenance budget, the homeowners association fees, the cost of utilities, and the asset management fees. In some embodiments, the market data may be for a specific location or region or may be specific to a certain property location. In some embodiments, each of the data points stored in the database may be used as an input into an algorithm to determine the net lease terms for the property owner 136, determine the rent for the specific property, and determine the profits or return on investment for the investors 138. In some embodiments, the starting market price may be the cost per square footage, the average cost of rent in a certain location, the average cost of rent in a certain location based on the number of bedrooms, the average cost of rent in a certain region of a city or town, etc. In some embodiments, the net lease module 104 may send a request to the expenses network 144 to receive relevant data points for a specific property location, for example, by using the mailing address.

An example expenses database is provided below.

| | Starting | Growth | | Vacancy | Rent | Home Price | Operating |
|---|---|---|---|---|---|---|---|
| Location | Market Rent | Rate | Inflation | Rate | Collectability | Appreciation | Expenses |
| Boston, MA | $4.60/sq. ft. | 5% | 7.70% | 0.47% | 95% | 8.11% | BostonOE.Data |
| New York, NY | $9.00/sq. ft. | 10% | 7.70% | 1.20% | 92% | 12% | NewYorkOE.Data |
| Los Angeles, CA | $7.00/sq. ft. | 8% | 7.70% | 3% | 91% | 10% | LosAngeles.Data |
| — | — | — | — | — | — | — | — |
| — | — | — | — | — | — | — | — |
| — | — | — | — | — | — | — | — |

The example expenses database contains a property owner ID, the property ID, the length of the lease or the years remaining on the net lease, the lease payment to the property owner 136, the annual increase of the net lease payment to the property owner, the fixed and variable costs per month for the property, the rent collected per month for the property, and the monthly profits for the property. In some embodiments, a property owner 136 may have multiple properties under a net lease with the net lease network 102. In some embodiments, the fixed and variable costs may differ for each property, or if there are multiple properties located within a certain radius, there may be one vendor 140 and/or one property manager 134 for each of the properties to lower the monthly fixed and variable costs. In some embodiments, the database may be shown as monthly, quarterly, or annual payments, expenses, profits, etc. In some embodiments, the investors 138 may receive a percentage of the monthly profits or may be paid out based on quarterly or annual profits.

An example owners database is provided below.

| Name | Owner ID | Property ID | Address | Square Footage | | Bedrooms | Bathrooms |
|---|---|---|---|---|---|---|---|
| John Smith | JS123 | JS123-001 | 123 main street, Boston, MA | 1,200 | sq. ft. | 2 | 1 |
| John Smith | JS123 | JS123-002 | 34 elm street, Boston, MA | 800 | sq. ft. | 1 | 1 |
| John Smith | JS123 | JS123-003 | 15 Maple Drive, Boston, MA | 1,500 | sq. ft. | 3 | 2 |

| | | | | | | |
|---|---|---|---|---|---|---|
| — | — | — | — | — | — | — |
| — | — | — | — | — | — | — |
| — | — | — | — | — | — | — |

The example owners database contains the list of owners interested in receiving net lease terms from the net lease network 102. The database contains the owner's name, the owner ID, the property ID, the property address, the square footage, the number of bedrooms, and the number of bathrooms. In some embodiments, the owner may send the net lease network 102 more data on the location, such as average utility bills, property tax, insurance costs, condition of the property, condition of current appliances, etc. In some embodiments, the owner may send the net lease network 102 the current rates they charge for rent, if the property is vacant or if it currently has renters, the application processes the owner uses for renters, etc.

An example parameters database is provided below.

| Location | Square Footage Range | Bedrooms | Bathrooms | Rent Range | Fixed Cost Range | Potential Profit Range |
|---|---|---|---|---|---|---|
| Boston, MA | 600-800 | Studio | 1 | $1,600-$2,000 | $80-$120 | $300-$500 |
| Boston, MA | 800-1,000 | 1 | 1 | $1,800-$2,200 | $100-$130 | $400-$600 |
| Boston, MA | 1,000-1,200 | 2 | 1 | $2,200-$2,700 | $110-$150 | $500-$600 |
| — | — | — | — | — | — | — |
| — | — | — | — | — | — | — |
| — | — | — | — | — | — | — |

The example parameters database contains the parameters created during the process described in the reserve module 106 used to determine if a potential property would be profitable for a residential net lease from the net lease network 102. The database contains the location or region, the square foot range of the property, the number of bedrooms, the number of bathrooms, the rent range that could be charged for the property, the average range of fixed and variable costs for the property, and the potential profit range of the property. In some embodiments, the database may contain a plurality of locations based on the region of the country, the state the property resides in, the city where the property is located, the town or section of a city the property is located, etc. In some embodiments, the parameters may be determined by the property's square footage, the number of bedrooms the property has, the rent that may be charged for the residential property, or a combination of the parameters.

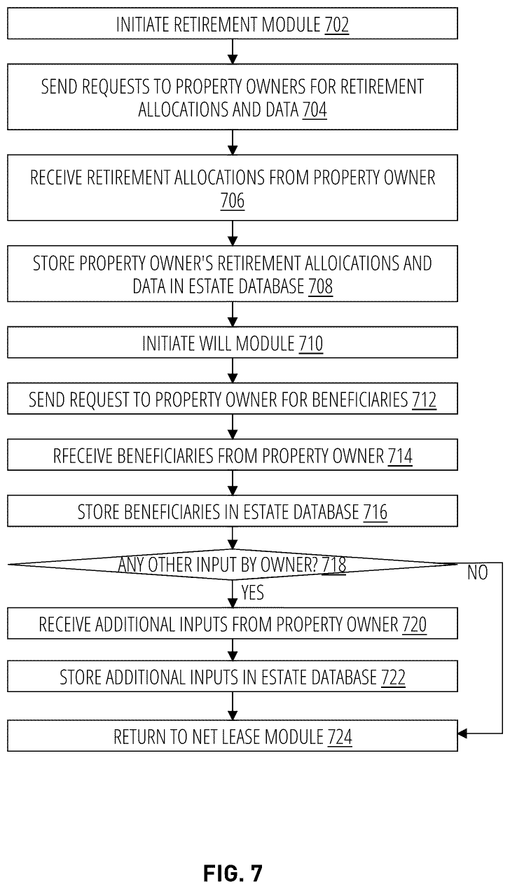

FIG. 7 displays an example method performed by the retirement module 124. Although the example method depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

The process begins with the retirement module 124 being initiated, at step 702, by the net lease module 104. In some embodiments, the retirement module 124 may be initiated by the property owner 136 if they desire to change any retirement allocations or adjustments to the will by signing into their net lease network 102 accounts through a username and password. The retirement module 124 sends, at step 704, a request to the property owner 136 for retirement allocations and retirement data. For example, the retirement module 124 sends a request to the property owner 136 for a percentage of their residential net lease payments to be allocated to a retirement fund or account, and the retirement data, such as the data related to the retirement funds or accounts. In some embodiments, the retirement account may be a separate bank account of the property owner 136, an investment portfolio, an IRA fund, a 401K, etc.

The retirement module 124 receives, at step 706, the retirement allocations and retirement data from the property owners 136. For example, the retirement module 124 receives a percentage of their residential net lease payments to be allocated to a retirement fund or account and the retirement data, such as the data related to the retirement funds or accounts. In some embodiments, the retirement account may be a separate bank account of the property owner 136, an investment portfolio, an IRA fund, a 401K, etc. The retirement module 124 stores, at step 708, the property owners 136 retirement allocations, and retirement data in the estate database 130. For example, the retirement module 124 stores the received data in the estate database 130, such as the property owner's 136 name, the property owner's 136 ID, the total amount of the lease payments made to the property owner 136 through their residential net lease terms, the retirement allocations from the total amount of the lease payments, the retirement account the retirement allocations are made to, etc. In some embodiments, the retirement account may be a separate bank account of the property owner 136, an investment portfolio, an IRA fund, a 401K, etc.

The retirement module 124 initiates, at step 708, the will module 126. For example, the will module 126 begins by being initiated by the retirement module 124. The will module 126 sends a request to the property owner 136 for the beneficiaries of their properties. The will module 126 receives the beneficiaries for the properties of the property owner 136. The will module 126 stores the beneficiaries for the properties of the property owner 136 in the estate database 130. The will module 126 determines if the property owner 136 has other inputs. If it is determined that the property owner 136 has any other inputs, the will module 126 receives the additional inputs from the property owners 136. The will module 126 stores the additional inputs from the property owner 136 in the estate database 130. If it is determined that the property owner 136 does not have any additional inputs or after the additional inputs have been stored in the estate database 130, the will module 126 returns to the net lease module 104.

The method may continue with the will module 126 being initiated, at step 710, by the retirement module 124. In some embodiments, the will module 126 may be initiated by the property owner 136 if they desire to change any retirement allocations or adjustments to the will by signing into their net lease network 102 accounts through the use of a username and password. The will module 126 sends, at step 712, a request to the property owner 136 for the beneficiaries for their properties. For example, the will module 126 sends a request to the property owner 136 for the beneficiaries of their property or properties at the time of their passing. In some embodiments, the beneficiaries may include the beneficiaries' name, date of birth, address, phone number, e-mail address, etc.

The will module 126 receives, at step 714, the beneficiaries for the properties of the property owner 136. For example, the will module 126 receives the beneficiaries of the property owner's 136 property or properties at the time of their passing. In some embodiments, the beneficiaries may include the beneficiaries' name, date of birth, address, phone number, e-mail address, etc. The will module 126 stores, at step 716, the beneficiaries for the properties of the property owner 136 in the estate database 130. For example, the will module 126 stores the beneficiaries of the property owner's 136 property or properties at the time of their passing. In some embodiments, the beneficiary's data may include the beneficiaries name, date of birth, address, phone number, e-mail address, etc. In some embodiments, the will module 126 may notify the beneficiary upon the death of the property owner 136 of their inheritance. In some embodiments, the will module 126 may contact the beneficiary to determine if the beneficiary would like to continue the original property owner's 136 residential net lease terms, generate a new agreement for a residential net lease, or terminate the agreement due to the death of the property owner 136.

The will module 126 determines, at decision block 718, if the property owner 136 has other inputs. For example, the property owner 136 may send additional information related to their last will and testament, such as beneficiaries for bank accounts, investments, gifts, trusts, etc. In some embodiments, the bank accounts of the property owner 136 may be a checking account, savings account, etc. In some embodiments, the investments of the property owner 136 may be a registered retirement savings plan (RRSP), a tax-free savings account (TFSA), an investment portfolio, an IRA fund, a 401K, etc. If it is determined that the property owner 136 has any other inputs, the will module 126 receives, at step 720, the additional inputs from the property owners 136. For example, the will module 126 receives additional inputs from the property owner 136, such as beneficiaries for bank accounts, investments, gifts, trusts, etc. In some embodiments, the bank accounts of the property owner 136 may be a checking account, savings account, etc. In some embodiments, the investments of the property owner 136 may be a registered retirement savings plan (RRSP), a tax-free savings account (TFSA), an investment portfolio, an IRA fund, a 401K, etc.

The will module 126 stores, at step 722, the additional inputs from the property owner 136 in the estate database 130. For example, the will module 126 stores the additional inputs from the property owner 136 in the estate database 130, such as beneficiaries for bank accounts, investments, gifts, trusts, etc. In some embodiments, the bank accounts of the property owner 136 may be a checking account, savings account, etc. In some embodiments, the investments of the property owner 136 may be a registered retirement savings plan (RRSP), a tax-free savings account (TFSA), an investment portfolio, an IRA fund, a 401K, etc. If it is determined that the property owner 136 does not have any additional inputs or after the additional inputs have been stored in the estate database 130, the will module 126 returns, at step 724, to the net lease module 104.

In some cases, the recommendation engine may analyze estate planning documents and provide suggestions for edits to mitigate risks while maximizing potential returns. The recommendation engine may utilize machine learning models to predict risks and estimate returns, allowing users to make informed decisions about their estate planning. The recommendation engine may begin with collecting data from two main sources: estate planning document data and risk modeling data, in some cases from the outputted potential return estimate and predicted risks from the machine-learning predictive and risk model.

The estate planning document data may include the contents, structure, and metadata of various documents, while the risk modeling data is generated by a separate machine learning model that predicts risks associated with different estate planning scenarios. Another dataset, return estimation data, is used to estimate potential returns on investment for various estate planning strategies.

The recommendation engine may include a risk prediction model and a return estimation model. The risk prediction model may take the estate planning document data as input and outputs a risk score for each section of the document. Meanwhile, the return estimation model may take the risk modeling data as input and estimates potential returns on investment for various strategies within each section of the document. The recommendation engine may then combine these two outputs to generate recommendations for edits that can mitigate risks while maximizing potential returns. This is done by analyzing the risk scores and return estimates for each section of the document, identifying areas where changes could improve the estate plan's overall performance. The resulting output includes a list of recommended edits, along with their associated risk scores and estimated returns.

For example, let's say we have an estate planning document that includes a will and a trust. The risk prediction model outputs a risk score of 0.8 for the will's beneficiary clause, indicating that updating this section could mitigate some risks. Meanwhile, the return estimation model estimates that making this change could result in a $100,000 increase in potential returns. Similarly, the risk prediction model outputs a risk score of 0.4 for the trust's provision for tax-efficient distribution of assets, and the return estimation model estimates that adding this provision could result in a $50,000 increase in potential returns.

The recommendation engine provides an editing interface that allows users to review these recommended edits, choose which ones to apply, and update the document with suggested changes. Overall, this recommendation engine is a powerful tool for estate planning professionals and individuals seeking to optimize their estate plans for maximum return and risk mitigation. By leveraging machine learning models and providing actionable recommendations, the recommendation engine empowers users to make informed decisions about their estate planning documents and achieve better outcomes.

In some cases, an example method of automating a residential net lease management tool that provides risk-return projections associated with net lease terms and financial planning data, includes receiving, over an expense network, market data associated with a specific region sent over a communication network at a net lease management server configured to communicate with at least one third-party application, initiating, by a net lease module, a reserve module, and generating, by the reserve module, net lease parameters for the specific region based on a calculated profitability evaluation based on the market data received via the expense network, where the calculated profitability evaluation determines a threshold margin based on a percentage of an average rental rate and average fixed costs in the specific region.

In some cases, an example method includes initiating, by the net lease module, an owner module, and identifying, by the owner module, properties that fall within the net lease parameters generated by the reserve module. In some cases, an example method initiating, by the net lease module, a manage module, and determining, by the manage module, fixed costs and variable costs based on data associated with at least one of the identified properties and extracted data points from stored invoice data, generating, by the reserve module, a set of net lease terms associated with the at least one of the properties identified by the net lease module, based on first inputs including the fixed costs and variable costs determined the manage module, where first weights are assigned to each first input, and receiving an approval from a property owner of the generated set of net lease terms. In some cases, an example method determining that the property owner is associated with financial planning data including at least one of retirement allocation data or estate planning data, and generating, by a first machine-learning model of a financial planning module, risk-return projections based on second inputs including the net lease terms and the financial planning data, where second weights are assigned to each second input, and causing to display the risk-return projections associated with the net lease terms and the financial planning data.

The computer-implemented method may also include further includes using a second machine-learning model to output the set of net lease terms, and where the machine-learning model determines the first weights based on training data including past net lease terms associated with the one or more regions. Other technical features may be readily apparent to one skilled in the art from the following figures, descriptions, and claims.

The computer-implemented method may also include further includes performing one or more simulations for comparable net lease terms and comparable financial planning data, and based on the performed simulations, causing to presenting one or more options of changes to the approved net lease terms and the financial planning data based on better risk-return projections for the comparable net lease terms and the comparable financial planning data. Other technical features may be readily apparent to one skilled in the art from the following figures, descriptions, and claims.

The computer-implemented method may also include further includes generating, using a recommendation engine, one or more recommendations for editing the estate planning data based on the risk-return projections, receiving a selection of approving one of the recommendations, and editing the estate planning data based on the approved recommendation. Other technical features may be readily apparent to one skilled in the art from the following figures, descriptions, and claims.

The computer-implemented method may also include where the first machine-learning model determines the second weights based on training data including past risk-return projections associated with past net lease terms and past financial planning data including at least one of past retirement allocation data or past estate planning data. Other technical features may be readily apparent to one skilled in the art from the following figures, descriptions, and claims.

The computer-implemented method may also include further includes using a recommendation machine-learning model to output the one or more recommendations for editing the estate planning data, and where the recommendation machine-learning model includes a risk prediction model and a return estimation model, receiving, by the risk prediction model, the estate planning data as an input and outputs a risk score for each section, receiving, by the return estimation model, at least part of the financial planning data and the risk-return projections as input and estimates potential returns on investment for each section, and combining the risk score for each section and the estimated potential returns on investment for each section to generate recommendations for edits for mitigating risks while maximizing potential returns. Other technical features may be readily apparent to one skilled in the art from the following figures, descriptions, and claims.

The computer-implemented method may also include further includes receiving a selection to approve one of the recommended edits, and editing the estate planning data based on the selection. Other technical features may be readily apparent to one skilled in the art from the following figures, descriptions, and claims. The computer-implemented method may also retrain the recommendation machine-learning model with new extracted historical data including the selection of the approved recommended edit.

FIG. 8 displays an example method performed by the connection module. Although the example method depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

The process begins with the connection module 128 being initiated, at step 802, by the net lease module 104. In some embodiments, the connection module 128 may be initiated every week, month, quarter, year, etc., by the net lease module 104 or the net lease network 102 to continuously keep the property owner's 136 estate planning data up to date and to provide the 3rd party estate planning network 144 with the most up to date data on the property owner's 136 property or properties. The connection module 128 sends, at step 804, a request to the property owner 136 for the estate planning company data. For example, the connection module 128 sends a request to the property owner 136 for the company or service that provides the estate planning for the property owner 136, such as a lawyer, accountant, financial planner, life insurance provider, banker, broker, etc. The connection module 128 receives, at step 806, the estate planning company data from the property owner 136. For example, the connection module 128 receives the company or service that provides the estate planning for the property owner 136, such as a lawyer, accountant, financial planner, life insurance provider, banker, broker, etc.

The connection module 128 connects, at step 808, to the 3rd party estate planning network 144. For example, the connection module 128 connects to the 3rd party estate planning network 144 that provides the property owner 136 with estate planning services. The 3rd party real estate planning network 144 may be an estate planning company, law firm, etc., that the property owner 136 uses for estate planning which may include retirement data, estate planning data, beneficiary data, etc. For example, estate planning is the process of anticipating and arranging, during a person's life, for the management and disposal of that person's estate during the person's life, in the event the person becomes incapacitated and after death. In some embodiments, the property owner's 136 estate planning may be performed or completed by a lawyer, accountant, financial planner, life insurance advisor, banker, and broker.

The connection module 128 sends, at step 810, a request to the 3rd party estate planning network 144 for the property owner's 136 data. For example, the connection module 128 sends a request to the 3rd party estate planning network 144 for the property owner's 136 estate planning data, such as the total amount of the lease payments made to the property owner 136 through their residential net lease terms, the retirement allocations from the total amount of the lease payments, the retirement account the retirement allocations are made to, the first property ID of the property owner 136, the beneficiary of the first property, the additional property ID of the property owner 136, the beneficiary of the additional property, the first bank account of the property owner 136, the beneficiary of the first bank account, the additional bank account of the property owner 136, the beneficiary of the additional bank account, the first investment of the property owner 136, the beneficiary of the first investment, the additional investment of the property owner 136, the beneficiary of the additional investment, and a data file containing the will of the property owner 136.

The connection module 128 receives, at step 812, the property owner's 136 estate planning data from the 3rd party estate planning network 144. For example, the connection module 128 receives the property owner's 136 estate planning data from the 3rd party estate planning network 144, such as the total amount of the lease payments made to the property owner 136 through their residential net lease terms, the retirement allocations from the total amount of the lease payments, the retirement account the retirement allocations are made to, the first property ID of the property owner 136, the beneficiary of the first property, the additional property ID of the property owner 136, the beneficiary of the additional property, the first bank account of the property owner 136, the beneficiary of the first bank account, the additional bank account of the property owner 136, the beneficiary of the additional bank account, the first investment of the property owner 136, the beneficiary of the first investment, the additional investment of the property owner 136, the beneficiary of the additional investment, and a data file containing the will of the property owner 136.

The connection module 128 stores, at step 814, the property owner's 136 estate planning data in the estate database 130. For example, the connection module 128 stores the property owner's 136 estate planning data in the estate database 130, such as the total amount of the lease payments made to the property owner 136 through their residential net lease terms, the retirement allocations from the total amount of the lease payments, the retirement account the retirement allocations are made to, the first property ID of the property owner 136, the beneficiary of the first property, the additional property ID of the property owner 136, the beneficiary of the additional property, the first bank account of the property owner 136, the beneficiary of the first bank account, the additional bank account of the property owner 136, the beneficiary of the additional bank account, the first investment of the property owner 136, the beneficiary of the first investment, the additional investment of the property owner 136, the beneficiary of the additional investment, and a data file containing the will of the property owner 136.

The connection module 128 determines, at decision block 816, if there are any updates to the property owner's 136 properties. For example, the connection module 128 may compare the received data from the 3rd party estate planning network 144 to the owners database 120 to determine if there is a difference in the property data, such as additional bedrooms, bathrooms, additions, renovations, property taxes, updates to square footage, etc. If it is determined that there are updates to the property owner's 136 property, the connection module 128 extracts, at step 818, the property data from the owners database 120. For example, the connection module 128 may determine that there is an update to the property owner's 136 based on the received data from the 3rd party estate planning network 144, and the connection module 128 extracts the property data from the owners database 120, such as additional bedrooms, bathrooms, additions, renovations, property taxes, updates to square footage, etc.

The connection module 128 sends, at step 820, the extracted property data from the owners database 120 to the 3rd party estate planning network 144. For example, the connection module 128 sends the property data extracted from the owners database 120 to the 3rd party estate planning network 144, such as the property address, the square footage, the number of bedrooms, the number of bathrooms, additions, renovations, property taxes, etc. If it is determined that there are no updates to the property owner's 136 property or after the data is sent to the 3rd party estate planning network 144, the connection module 128 returns, at step 822, to the net lease module 104.

An example estate database is provided below.

| | | | Retirement | Retirement |
|---|---|---|---|---|
| Name | Owner ID | Lease Amount | Allocations | Account |
| John Smith | JS123 | $6,000/Month | 10%/Month | Ending in 1324 |
| Tim | TM456 | $8,300/Month | 8%/Month | Ending in 7894 |
| Hannah | HY789 | $7,000/Month | 5%/Month | Ending in 4567 |

| Name | Property #1 | Beneficiary | Property #N ID | Beneficiary | Bank Account #1 | Beneficiary | Bank Account #N |
|---|---|---|---|---|---|---|---|
| John Smith | JS123-001 | Spouse | JS123-002 | Children | Ending in 3691 | Spouse | Ending in 7538 |
| Tim | TM456-001 | Brother | TM456-002 | Spouse | Ending in 7418 | Spouse | Ending in 1594 |
| Matthews | | | | | | | |
| Hannah | HY789-001 | Parents | HY789-002 | Children | Ending in 8529 | Children | Ending in 4196 |
| Young | | | | | | | |

| Name | Beneficiary | Investment # | Beneficiary | Investment # N | Beneficiary | Will |
|---|---|---|---|---|---|---|
| John Smith | Children | RRSP | Spouse | TFSA | Children | JSWill.Data |
| Tim | Children | RRSP | Spouse | Stock Portfolio | Children | TMWIll.Data |
| Matthews | | | | | | |
| Hannah | Spouse | RRSP | Children | TFSA | Spouse | HYWill.Data |
| Young | | | | | | |

The example estate database contains the estate planning and retirement data of the property owners 136, which is collected either through the processes described in the retirement module 124 and will module 126 or the connection module 128. The database contains the name of the property owner 136, the property owner ID 136, the total amount of the lease payments made to the property owner 136 through their residential net lease terms, the retirement allocations from the total amount of the lease payments, the retirement account the retirement allocations are made to, the first property ID of the property owner 136, the beneficiary of the first property, the additional property ID of the property owner 136, the beneficiary of the additional property, the first bank account of the property owner 136, the beneficiary of the first bank account, the additional bank account of the property owner 136, the beneficiary of the additional bank account, the first investment of the property owner 136, the beneficiary of the first investment, the additional investment of the property owner 136, the beneficiary of the additional investment, and a data file containing the will of the property owner 136. In some embodiments, the database may contain additional information about the property, such as the address, the renter information, the rental agreement, the yearly increase in the payments for the residential net lease, etc.

In some embodiments, the retirement account may be a separate bank account of the property owner 136, an investment portfolio, an IRA fund, a 401K, etc. In some embodiments, the beneficiaries may include the beneficiaries' name, date of birth, address, phone number, e-mail address, etc. In some embodiments, the bank accounts of the property owner 136 may be a checking account, savings account, etc.

In some embodiments, the investments of the property owner 136 may be a registered retirement savings plan (RRSP), a tax-free savings account (TFSA), an investment portfolio, an IRA fund, a 401K, etc. In some embodiments, the will data file may include the property owner's 136 last will and testament that may be signed and notarized in which a copy is stored in the database on the net lease network 102. s performed in the processes and methods may be implemented in differing order.

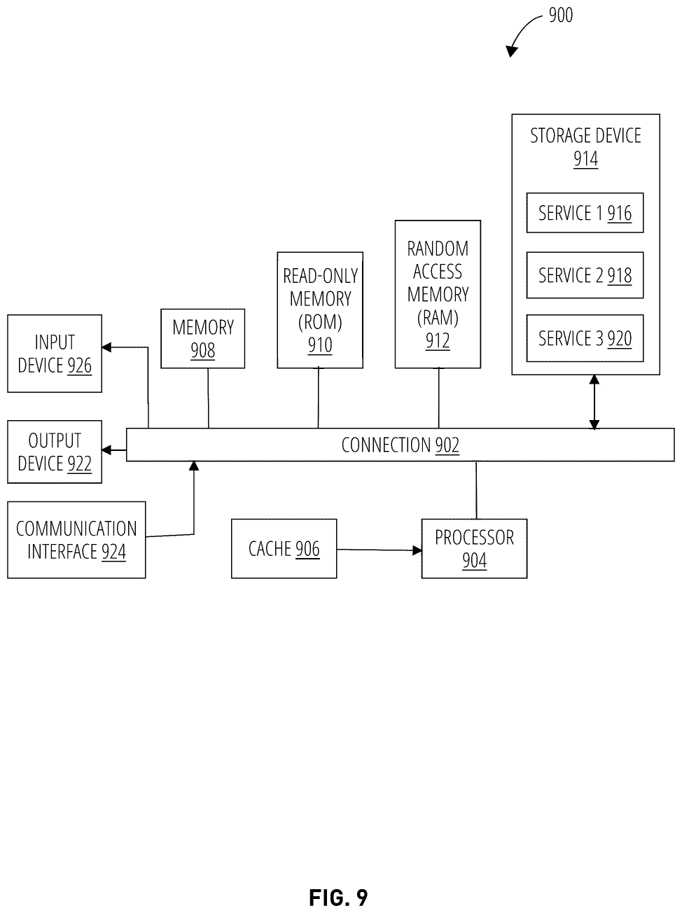

FIG. 9 illustrates a block diagram of an exemplary computing system that may be used to implement an embodiment of the present invention. The example of computer system 900 can be for example any computing device making up 100, or any component thereof in which the components of the system are in communication with each other using connection 902. Connection 902 can be a physical connection via a bus, or a direct connection into processor 904, such as in a chipset architecture. Connection 902 can also be a virtual connection, networked connection, or logical connection.

In some embodiments, computing computer system 900 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing computer system 900 includes at least one processing unit (CPU or processor) 904 and connection 902 that couples various system components including system memory 908, such as read-only memory (ROM) 910 and random-access memory (RAM) 912 to processor 904. Computing system 500 can include a cache of high-speed memory 908 connected directly with, in close proximity to, or integrated as part of processor 904.

Processor 904 can include any general-purpose processor and a hardware service or software service, such as services 916, 918, and 920 stored in storage devices 914, configured to control processor 904 as well as a special-purpose processor where software instructions are incorporated into the actual processor design. Processor 904 may essentially be a completely self-contained computing system, containing multiple cores or processors, a bus, memory controller, cache, etc. A multi-core processor may be symmetric or asymmetric.

To enable user interaction, computing computer system 900 includes an input device 926, which can represent any number of input mechanisms, such as a microphone for speech, a touch-sensitive screen for gesture or graphical input, keyboard, mouse, motion input, speech, etc. Computing system 900 can also include output device 922, which can be one or more of a number of output mechanisms known to those of skill in the art. In some instances, multimodal systems can enable a user to provide multiple types of input/output to communicate with computer system 900. Computing system 900 can include communication interface 924, which can generally govern and manage the user input and system output. There is no restriction on operating on any particular hardware arrangement, and therefore the basic features here may easily be substituted for improved hardware or firmware arrangements as they are developed.

Storage device 914 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 914 can include software services, servers, services, etc., that when the code that defines such software is executed by the processor 904, it causes the system to perform a function. In some embodiments, a hardware service that performs a particular function can include the software component stored in a computer-readable medium in connection with the hardware components, such as processor 904, connection 902, output device 922, etc., to carry out the function.

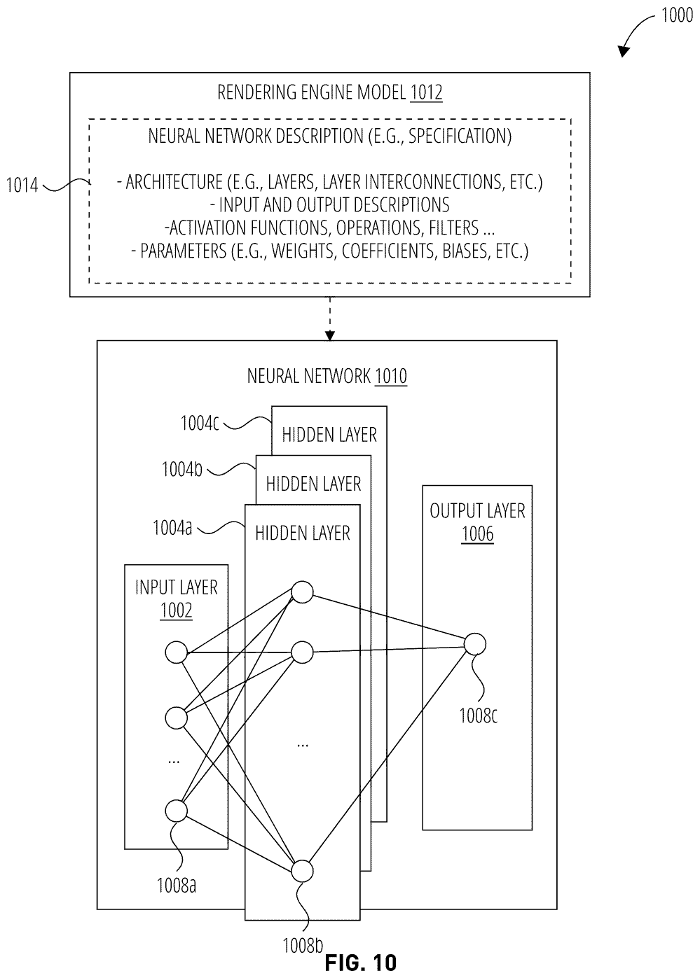

FIG. 10 illustrates an example neural network architecture.

Architecture 1000 includes a neural network 1004c defined by an example neural network description 1008a in node 1010c (neural controller). The neural network 6100 can represent a neural network implementation of a rendering engine for rendering media data. The neural network description 1008a can include a full specification of the neural network 1004c, including the neural network architecture 1000. For example, the neural network description 1008a can include a description or specification of the architecture 1000 of the neural network 1004c (e.g., the layers, layer interconnections, number of nodes in each layer, etc.); an input and output description which indicates how the input and output are formed or processed; an indication of the activation functions in the neural network, the operations or filters in the neural network, etc.; neural network parameters such as weights, biases, etc.; and so forth.

The neural network 1004c reflects the architecture 1000 defined in the input layer 1002. In this example, the neural network 1004c includes an input layer 1002, which includes input data, such the net lease terms and the financial planning data. The neural network 1004c includes hidden layers 1004a through 1004 N (collectively “1004” hereinafter). The hidden layers 1004 can include n number of hidden layers, where n is an integer greater than or equal to one. The number of hidden layers can include as many layers as needed for a desired processing outcome and/or rendering intent.

The neural network 1004c further includes an output layer 1004b that provides an output (e.g., rendering output) resulting from the processing performed by the hidden layers 1004. In one illustrative example, the output layer 1004b can provide risk-return projections, set of net lease terms, one or more recommendations for editing the estate planning data The neural network 1004c in this example is a multi-layer neural network of interconnected nodes. Each node can represent a piece of information. Information associated with the nodes is shared among the different layers and each layer retains information as information is processed. In some cases, the neural network 1004c can include a feed-forward neural network, in which case there are no feedback connections where outputs of the neural network are fed back into itself. In other cases, the neural network 1004c can include a recurrent neural network, which can have loops that allow information to be carried across nodes while reading in input. Information can be exchanged between nodes through node-to-node interconnections between the various layers.

Nodes of the input layer 1002 can activate a set of nodes in the first hidden layer 504a. For example, as shown, each of the input nodes of the input layer 1002 is connected to each of the nodes of the first hidden layer 504a. The nodes of the hidden layers hidden layer 504a can transform the information of each input node by applying activation functions to the information. The information derived from the transformation can then be passed to and can activate the nodes of the next hidden layer (e.g., 504b), which can perform their own designated functions. Example functions include convolutional, up-sampling, data transformation, pooling, and/or any other suitable functions. The output of the hidden layer (e.g., 504b) can then activate nodes of the next hidden layer (e.g., 604N), and so on. The output of the last hidden layer can activate one or more nodes of the output layer 1004b, at which point an output is provided. In some cases, while nodes (e.g., nodes 508a, 508b, 508c) in the neural network 1004c are shown as having multiple output lines, a node has a single output and all lines shown as being output from a node represent the same output value. In some cases, each node or interconnection between nodes can have a weight that is a set of parameters derived from training the neural network 1004c.

For example, an interconnection between nodes can represent a piece of information learned about the interconnected nodes. The interconnection can have a numeric weight that can be tuned (e.g., based on a training dataset), allowing the neural network 1004c to be adaptive to inputs and able to learn as more data is processed. The neural network 1004c can be pre-trained to process the features from the data in the input layer 1002 using the different hidden layers 1004 in order to provide the output through the output layer 1004b. In an example in which the neural network 1004c is used to identify a set of net lease terms, the neural network 1004c can be trained using training data that includes training data including past net lease terms associated with the identified properties. For instance, training images can be input into the neural network 1004c, which can be processed by the neural network 1004c to generate outputs which can be used to tune one or more aspects of the neural network 1004c, such as weights, biases, etc. In some cases, the neural network 1004c can adjust weights of nodes using a training process called backpropagation. Backpropagation can include a forward pass, a loss function, a backward pass, and a weight update. The forward pass, loss function, backward pass, and parameter update is performed for one training iteration.

The process can be repeated for a certain number of iterations for each set of training media data until the weights of the layers are accurately tuned. For a first training iteration for the neural network 1004c, the output can include values that do not give preference to any particular class due to the weights being randomly selected at initialization. For example, if the output is a vector with probabilities that the object includes different product(s) and/or different users, the probability value for each of the different product and/or user may be equal or at least very similar (e.g., for ten possible products or users, each class may have a probability value of 0.1). With the initial weights, the neural network 1004c is unable to determine low level features and thus cannot make an accurate determination of what the classification of the object might be. A loss function can be used to analyze errors in the output. Any suitable loss function definition can be used. The loss (or error) can be high for the first training dataset (e.g., images) since the actual values will be different than the predicted output.

The goal of training is to minimize the amount of loss so that the predicted output comports with a target or ideal output. The neural network 1004c can perform a backward pass by determining which inputs (weights) most contributed to the loss of the neural network 1004c and can adjust the weights so that the loss decreases and is eventually minimized. A derivative of the loss with respect to the weights can be computed to determine the weights that contributed most to the loss of the neural network 1004c. After the derivative is computed, a weight update can be performed by updating the weights of the filters. For example, the weights can be updated so that they change in the opposite direction of the gradient. A learning rate can be set to any suitable value, with a high learning rate including larger weight updates and a lower value indicating smaller weight updates.

The neural network 1004c can include any suitable neural or deep learning network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. In other examples, the neural network 1004c can represent any other neural or deep learning network, such as an autoencoder, a deep belief nets (DBNs), a recurrent neural networks (RNNs), etc.

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some aspects, a service can be software that resides in memory of a client device and/or one or more servers of a content management system and perform one or more functions when a processor executes the software associated with the service. In some aspects, a service is a program or a collection of programs that carry out a specific function. In some aspects, a service can be considered a server. The memory can be a non-transitory computer-readable medium.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general-purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

What is claimed is:

1. A computer-implemented method of automating a residential net lease management tool that provides risk-return projections associated with net lease terms and financial planning data, comprising:
receiving, over an expense network, market data associated with a specific region sent over a communication network at a net lease management server configured to communicate with at least one third-party application;
initiating, by a net lease module, a reserve module;
generating, by the reserve module, net lease parameters for the specific region based on a calculated profitability evaluation based on the market data received via the expense network, wherein the calculated profitability evaluation determines a threshold margin based on a percentage of an average rental rate and average fixed costs in the specific region;
initiating, by the net lease module, an owner module;
identifying, by the owner module, properties that fall within the net lease parameters generated by the reserve module;
initiating, by the net lease module, a manage module;
determining, by the manage module, fixed costs and variable costs based on data associated with at least one of the identified properties and extracted data points from stored invoice data;
generating, by the reserve module, a set of net lease terms associated with the at least one of the properties identified by the net lease module, based on first inputs including the fixed costs and variable costs determined the manage module, wherein first weights are assigned to each first input;
receiving an approval from a property owner of the generated set of net lease terms;
determining that the property owner is associated with financial planning data including at least one of retirement allocation data or estate planning data;
generating, by a first machine-learning model of a financial planning module, risk-return projections based on second inputs including the net lease terms and the financial planning data, wherein second weights are assigned to each second input; and
causing to display the risk-return projections associated with the net lease terms and the financial planning data.

2. The computer-implemented method of claim 1, further comprising:
using a second machine-learning model to output the set of net lease terms, and wherein the machine-learning model determines the first weights based on training data including past net lease terms associated with the identified properties.

3. The computer-implemented method of claim 1, further comprising:
performing one or more simulations for comparable net lease terms and comparable financial planning data; and
based on the performed simulations, causing to presenting one or more options of changes to the approved net lease terms and the financial planning data based on better risk-return projections for the comparable net lease terms and the comparable financial planning data.

4. The computer-implemented method of claim 1, further comprising:
generating, using a recommendation engine, one or more recommendations for editing the estate planning data based on the risk-return projections;
receiving a selection of approving one of the recommendations; and
editing the estate planning data based on the approved recommendation.

5. The computer-implemented method of claim 4, wherein the first machine-learning model determines the second weights based on training data including past risk-return projections associated with past net lease terms and past financial planning data including at least one of past retirement allocation data or past estate planning data.

6. The computer-implemented method of claim 4, further comprising:
using a recommendation machine-learning model to output the one or more recommendations for editing the estate planning data, and wherein the recommendation machine-learning model includes a risk prediction model and a return estimation model;
receiving, by the risk prediction model, the estate planning data as an input and outputs a risk score for each section;
receiving, by the return estimation model, at least part of the financial planning data and the risk-return projections as input and estimates potential returns on investment for each section; and
combining the risk score for each section and the estimated potential returns on investment for each section to generate recommendations for edits for mitigating risks while maximizing potential returns.

7. The computer-implemented method of claim 6, further comprising:
receiving a selection to approve one of the recommended edits; and
editing the estate planning data based on the selection.

8. The computer-implemented method of claim 7, further comprising:
retraining the recommendation machine-learning model with new extracted historical data including the selection of the approved recommended edit.

9. The computer-implemented method of claim 1, further comprising:
recording, by an accounting module in a reserve database associated with a single reserve fund, a first accounting for a first amount funded by one or more investors that are not the respective owners; and
recording, by the accounting module in the reserve database associated with the single reserve fund, a second accounting for a second amount remunerated to the investors based on determined profit margins over term of lease and the net lease terms stored at the lease database; and
sending, based upon the accountings of the reserve database over the communication network, an instruction to trigger a transfer to the single reserve fund.

10. The computer-implemented method of claim 1, wherein the market data includes at least one of starting market rent, market growth rate, inflation rate, vacancy rate, rent collectability rate, home price appreciation, operating expenses, local taxes, insurance rates, management amounts, maintenance budget, homeowner's association amounts, cost of utilities, or asset management amounts.

11. The computer-implemented method of claim 1, wherein the inputs include at least one of average rent in one or more regions associated with the identified properties, square footage of the respective property, market growth rate, inflation rate, vacancy rate, rent collectability rate, home price appreciation, or operating expenses.

12. A system for automating a residential net lease management tool for providing risk-return projections associated with net lease terms and financial planning data, comprising:
a storage configured to store instructions;
a net lease module that controls a reserve module, an owner module, a manage module, and an enhancement module;
the reserve module that generates a plurality of net lease parameters for different regions;
the owner module that identifies replacement properties that fall within a particular net lease parameter;
the manage module that determines fixed costs and variable costs;
the enhancement module that generates stress scenarios;
a financial planning module that generates risk-return projections based on selected net lease terms and selected financial planning data; and
one or more processors configured to execute the instructions and cause the one or more processors to:
receiving, over an expense network, market data associated with a specific region sent over a communication network at a net lease management server configured to communicate with at least one third-party application;
initiating, by the net lease module, the reserve module;
generating, by the reserve module, net lease parameters for the specific region based on a calculated profitability evaluation based on the market data received via the expense network, wherein the calculated profitability evaluation determines a threshold margin based on a percentage of an average rental rate and average fixed costs in the specific region;
initiating, by the net lease module, the owner module;
identifying, by the owner module, properties that fall within the net lease parameters generated by the reserve module;
initiating, by the net lease module, the manage module;
determining, by the manage module, fixed costs and variable costs based on data associated with at least one of the identified properties and extracted data points from stored invoice data;
generating, by the reserve module, a set of net lease terms associated with the at least one of the properties identified by the net lease module, based on inputs including the fixed costs and variable costs determined the manage module, wherein weights are assigned to each input;
receiving an approval from a property owner of the generated set of net lease terms;
determining that the property owner is associated with financial planning data including at least one of retirement allocation data or estate planning data;
generating, by a first machine-learning model of the financial planning module, risk-return projections based on second inputs including the net lease terms and the financial planning data, wherein second weights are assigned to each second input; and
causing to display the risk-return projections associated with the net lease terms and the financial planning data.

13. The system of claim 12, wherein the one or more processors are configured to execute the instructions and cause the one or more processors to:
using a second machine-learning model to output the set of net lease terms, and wherein the machine-learning model determines the weights based on training data including past net lease terms associated with the one or more regions.

14. The system of claim 12, wherein the one or more processors are configured to execute the instructions and cause the one or more processors to:
perform one or more simulations for comparable net lease terms and comparable financial planning data; and
based on the performed simulations, cause to presenting one or more options of changes to the approved net lease terms and the financial planning data based on better risk-return projections for the comparable net lease terms and the comparable financial planning data.

15. The system of claim 12, wherein the one or more processors are configured to execute the instructions and cause the one or more processors to:
generate, using a recommendation engine, one or more recommendations for editing the estate planning data based on the risk-return projections;
receive a selection of approving one of the recommendations; and
edit the estate planning data based on the approved recommendation.

16. The system of claim 15, wherein the first machine-learning model determines the second weights based on training data including past risk-return projections associated with past net lease terms and past financial planning data including at least one of past retirement allocation data or past estate planning data.

17. The system of claim 15, wherein the processor is configured to execute the instructions and cause the one or more processors to:
using a recommendation machine-learning model to output the one or more recommendations for editing the estate planning data, and wherein the recommendation machine-learning model includes a risk prediction model and a return estimation model;
receiving, by the risk prediction model, the estate planning data as an input and outputs a risk score for each section;
receiving, by the return estimation model, at least part of the financial planning data and the risk-return projections as input and estimates potential returns on investment for each section; and
combining the risk score for each section and the estimated potential returns on investment for each section to generate recommendations for edits for mitigating risks while maximizing potential returns.

18. The system of claim 17, wherein the processor is configured to execute the instructions and cause the one or more processors to:
receiving a selection to approve one of the recommended edits; and
editing the estate planning data based on the selection.

19. A non-transitory computer readable medium comprising instructions, the instructions, when executed by a computing system, cause the computing system to:
receive, over an expense network, market data associated with a specific region sent over a communication network at a net lease management server configured to communicate with at least one third-party application;
initiate, by a net lease module, a reserve module;
generate, by the reserve module, net lease parameters for the specific region based on a calculated profitability evaluation based on the market data received via the expense network, wherein the calculated profitability evaluation determines a threshold margin based on a percentage of an average rental rate and average fixed costs in the specific region;
initiate, by the net lease module, an owner module;
identify, by the owner module, properties that fall within the net lease parameters generated by the reserve module;
initiate, by the net lease module, a manage module;
determine, by the manage module, fixed costs and variable costs based on data associated with at least one of the identified properties and extracted data points from stored invoice data;
generate, by the reserve module, a set of net lease terms associated with the at least one of the properties identified by the net lease module, based on inputs including the fixed costs and variable costs determined the manage module, wherein weights are assigned to each input;
receive an approval from a property owner of the generated set of net lease terms;
determining that the property owner is associated with financial planning data including at least one of retirement allocation data or estate planning data;
generate, by a first machine-learning model of a financial planning module, risk-return projections based on second inputs including the net lease terms and the financial planning data, wherein second weights are assigned to each second input; and
cause to display the risk-return projections associated with the net lease terms and the financial planning data.

20. The non-transitory computer readable medium of claim 19, wherein the instructions further cause the computing system to:
use a second machine-learning model to output the set of net lease terms, and wherein the machine-learning model determines the first weights based on training data including past net lease terms associated with the identified properties.
